(19) United States
(12) Patent Application Publication
(10) Pub. No.: US 2026/0289180 A1
(43) Pub. Date: Sep. 24, 2026

(54) SYSTEM

(71) Applicant: SoftBank Group Corp., Tokyo (JP)

(72) Inventor: Shiki TAKAUCHI, Tokyo (JP)

(73) Assignee: SoftBank Group Corp., Tokyo (JP)

(21) Appl. No.: 19/567,049

(22) Filed: Mar. 14, 2026

(30) Foreign Application Priority Data
Mar. 19, 2025 (JP) 2025-045133

(51) Int. Cl. G06F 40/40; G06F 40/166; G06F 40/253; G06F 40/268; G06F 40/284; G06Q 30/0251

(52) U.S. Cl. CPC G06F 40/40; G06F 40/166; G06F 40/253; G06F 40/268; G06F 40/284; G06Q 30/0269

(57) ABSTRACT

A system includes a processor that is configured to receive product information as an input, analyze the product information using natural language processing techniques, and perform preprocessing on data included in the product information, generate, based on the preprocessed data, a prompt for instructing a generative AI model to automatically generate a conversation-style advertisement, adjust the generated advertisement based on an emotional state of a user, and output the adjusted advertisement in an optimal format.

### CROSS-REFERENCE TO RELATED APPLICATION

This application is based on and claims priority under 35 USC 119 from Japanese Patent Application No. 2025-045133 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional advertisement generation systems that utilize generative AI models typically generate advertisement content from product information in a one-way, static manner. Such systems often lack sophisticated preprocessing of product information using natural language processing techniques, and therefore cannot fully extract or structure the semantic features of the product information prior to generation. As a result, the generated advertisements may be generic, poorly aligned with the detailed attributes of the product, or insufficiently tailored to different advertising formats such as conversation-style scripts or comic-style creative works.

Furthermore, conventional systems generally do not appropriately consider the emotional state of the user who views or uses the generated advertisements. Without dynamic adjustment of advertisement content based on the user's emotional state, it is difficult to maximize engagement, persuasive power, and user satisfaction. Additionally, when only a single prompt is used for a given set of product information, the range of variations in the generated advertisements is limited, and it becomes difficult to flexibly create multiple, diverse advertisements for the same product in response to different marketing goals or user segments.

Accordingly, there is a need for a system that can: (i) receive and preprocess product information using natural language processing techniques to generate suitable prompts; (ii) automatically generate conversation-style and other creative advertisements such as comic-style advertisements using a generative AI model; (iii) generate and use different prompts to obtain multiple, diverse advertisements for the same product information; and (iv) adjust and optimize the generated advertisements based on the emotional state of the user, and output the advertisements in an optimal format.

### SUMMARY

In order to solve the above-described problems, a system according to one embodiment comprises a processor, wherein the processor is configured to receive product information as an input, analyze the product information using natural language processing techniques, and perform preprocessing on data included in the product information. The processor is further configured to generate, based on the preprocessed data, a prompt for instructing a generative AI model to automatically generate a conversation-style advertisement, to adjust the generated advertisement based on an emotional state of a user, and to output the adjusted advertisement in an optimal format.

In one embodiment, the processor is configured to generate, based on the product information input by the user, a prompt for instructing the generative AI model to generate a creative advertisement in a comic format. By generating prompts specialized for comic-style expressions, the system can output creative advertisements that include, for example, character dialogues, panel descriptions, and scene transitions suitable for comic media, in addition to conversation-style scripts.

In another embodiment, the processor is configured to use different prompts to change content of an advertisement to be generated so that different advertisements are generatable for identical product information. By varying prompt content, tone, structure, or target audience specification, the system enables creation of multiple, diverse advertisements from the same product information. Furthermore, the processor is configured to generate a prompt for instructing optimization of the advertisement in accordance with the emotional state of the user. By incorporating information representing the user's emotional state into the prompt or into a post-processing instruction, the system can modify elements such as wording, emotional tone, emphasis, and presentation format, thereby providing advertisements that are dynamically optimized and more effective for users in different emotional states.

The term “product information” refers to information relating to a product, including at least a product name, a description of features, functions, performance, specifications, or benefits of the product, and optionally additional metadata such as target users, price range, or usage scenes.

The term “natural language processing techniques” refers to computational techniques for processing text or speech expressed in human language, including, for example, tokenization, morphological analysis, part-of-speech tagging, syntactic parsing, semantic analysis, entity extraction, sentiment analysis, and text normalization.

The term “preprocessing” refers to processing performed on the product information before input to a generative AI model, including, for example, cleaning, normalizing, segmenting, structuring, summarizing, or otherwise transforming the product information into a form suitable for prompt generation or model input.

The term “prompt” refers to text or structured data that is provided as an instruction or input condition to a generative AI model, the prompt specifying, for example, the type, style, format, content constraints, or target of an advertisement to be generated.

The term “generative AI model” refers to a machine learning model that is configured to generate content, such as text, images, or structured representations, based on an input prompt, the model including, for example, a large language model, a multimodal model, or another generative neural network.

The term “conversation-style advertisement” refers to advertisement content expressed primarily as a dialogue or script between two or more characters, including conversational lines, character turns, and optionally scene descriptions, so that the advertisement takes the form of a mini-play or dramatized conversation.

The term “comic format” refers to an advertisement format that is suitable for expression as a comic, including, for example, panels, scenes, character dialogues in speech balloons, narration boxes, and visual or situational descriptions that can be illustrated.

The term “creative advertisement in a comic format” refers to advertisement content that is generated to be expressed as a comic, including descriptions of characters, panels, scenes, dialogues, and narrative flow in a manner that can be converted into or directly used as comic artwork.

The term “emotional state of a user” refers to an affective condition of a user, such as happiness, sadness, excitement, boredom, anxiety, calmness, or other psychological or emotional states, which may be estimated, detected, or inferred from user inputs, behavior, biometric information, or explicit feedback.

The term “adjust the generated advertisement based on an emotional state of a user” refers to modifying at least one element of the generated advertisement, such as wording, tone, intensity of expressions, level of humor, structure, or emphasis, in response to the emotional state of the user so as to increase relevance, comfort, or persuasive effect.

The term “optimal format” refers to a presentation format of the advertisement that is selected as suitable under given conditions, including, for example, a text script, a structured script for video production, a comic storyboard, or a layout optimized for a particular display device or user preference.

The term “different prompts” refers to two or more prompts that differ in at least one aspect, such as wording, style instruction, target audience specification, emotional tone, level of detail, scenario setting, or output constraints, such that they cause a generative AI model to generate different advertisement content from the same product information.

The term “diverse advertisements” refers to multiple advertisements that differ from each other in at least one aspect of content, such as storyline, characters, tone, emphasis on product features, visual or verbal style, or intended audience segment, even when generated from the same underlying product information.

The term “optimization of the advertisement” refers to adjusting or selecting characteristics of the advertisement, including content, tone, structure, and format, in order to improve one or more criteria, such as user engagement, clarity, emotional resonance, or suitability to the user's emotional state or viewing environment.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

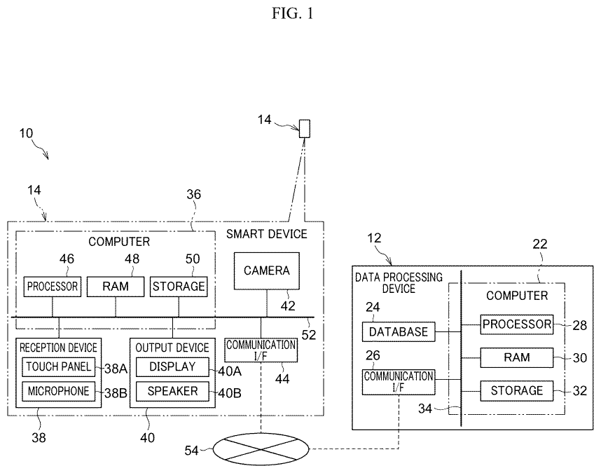

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

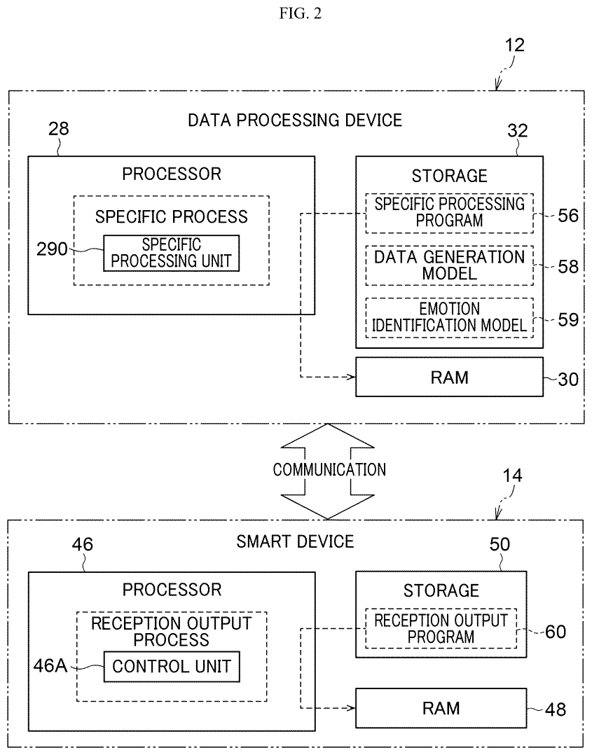

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented advertising and recommendation systems typically generate fixed or template-based content from product information. Such systems often rely on simple rule engines or static content libraries, and therefore cannot flexibly adapt the generated content to nuanced product descriptions, user emotional states, or evolving usage patterns. As a result, the content delivered to users is frequently generic, repetitive, and poorly aligned with the user's real-time needs or reactions.

Further, in many existing systems, the generation of recommendation information or advertising content is decoupled from a structured data flow on the server side. Product-related information is sometimes processed only transiently, without being stored and reused in a structured storage area, and without being tightly integrated with natural language processing and modern generative AI models. This architecture limits the ability of the system to systematically modify input instructions to such models, to perform iterative optimization, or to generate multiple diverse outputs for the same underlying product-related information.

In addition, known systems generally do not use the emotional state or reaction state of a user as a first-class, machine-processed parameter in the generation and adjustment of prompt sentences supplied to a generative AI model. Consequently, the server-side control logic does not fully leverage user feedback signals to tune prompts, adjust recommendation content, or refine the presentation format of the generated information. This leads to suboptimal utilization of computational resources and model capabilities, and fails to improve the efficiency and quality of the computer's operation in generating and presenting recommendations.

Furthermore, many existing solutions are not designed to modulate prompt sentences and model interactions in a structured, programmatic way that explicitly changes prompts even for identical product-related information, in order to obtain diverse outputs from a generative AI model. Without such prompt management, the system cannot systematically explore different content variants, cannot effectively personalize or A/B test content at scale, and cannot create more engaging interactive advertising experiences, such as conversational or story-like product presentations.

Accordingly, there is a need for a computer-implemented system that improves the functioning of the server and associated software components by: (i) managing product-related information as structured data; (ii) performing server-side natural language processing on such data; (iii) constructing, modifying, and reusing prompt sentences for a generative AI model in a controlled manner; and (iv) dynamically adjusting both the generated content and its presentation format based on user emotional or reaction states and usage history. Such a system should be capable of generating multiple, mutually different recommendation or advertising outputs for the same product-related information, thereby enhancing the efficiency and technical capability of the computing environment in which the advertising and recommendation processes are executed.

The specific processing by the specific processing unit 290 of the data processing device 12 in Example 1 is realized by the following means.

The present invention provides a server comprising a processor configured to control presentation of an information input screen on a terminal to receive product-related information as character data from a user, to receive communication data including the product-related information from the terminal, to store the product-related information in a structured storage area and to retrieve the product-related information from the structured storage area, to generate a prompt sentence as an instruction sentence for input to a generative AI model based on the retrieved product-related information, to transmit inquiry data including the prompt sentence to the generative AI model and to acquire response data including recommendation information from the generative AI model, to generate display data for presenting the recommendation information in association with the product-related information and to transmit the display data to the terminal, to perform natural language processing on the product-related information and to preprocess the prompt sentence based on a result of the natural language processing, and to change at least one of the prompt sentence and the display data in accordance with an emotional state or a reaction state of the user and to change the prompt sentence even when the product-related information is identical so as to obtain mutually different recommendation information or advertising information from the generative AI model. This enables an improvement in computer functionality by allowing the server to manage product-related data and user state as structured inputs to a generative AI workflow, to programmatically construct and vary prompt sentences, to generate diverse and contextually optimized recommendation or advertising outputs for identical product-related information, and to dynamically adapt both the generated content and its presentation format in response to user emotional or reaction states, thereby enhancing the efficiency, flexibility, and technical performance of the advertising and recommendation processing executed by the computing system.

The term “system” refers to a combination of hardware and software components, including at least one processor, memory, storage, communication interfaces, and executable programs, that cooperatively perform the functions described in the claims.

The term “processor” refers to one or more hardware processing units, such as a central processing unit or other processing circuitry, that execute instructions to perform logical operations, control data flow, and implement the functions recited in the claims.

The term “terminal” refers to an electronic computing apparatus, such as a client device, that provides a user interface, transmits data to a server, and receives display data from the server over a communication network.

The term “user interface” refers to a set of visual, auditory, or tactile elements presented on the terminal, such as screens, forms, buttons, and input fields, through which a user can input information and view output information.

The term “information input screen” refers to a graphical user interface component presented on the terminal that includes at least one input field or interactive element configured to receive product-related information as character data from a user.

The term “product-related information” refers to information that describes or identifies a product or service, including but not limited to a product name, attributes, specifications, features, descriptions, intended use, or marketing messages, expressed as character data.

The term “character data” refers to information represented as sequences of characters, such as letters, numbers, symbols, and punctuation, typically encoded in a character encoding scheme suitable for text processing.

The term “communication data” refers to data transmitted between the terminal and the server via a communication network, including at least the product-related information and optionally metadata such as timestamps, user identifiers, or session identifiers.

The term “structured storage area” refers to a logically organized data storage resource, such as a database or data table, in which information is stored according to a defined schema to allow efficient retrieval, update, and management.

The term “storage” refers to non-transitory computer-readable media or other hardware components that retain data, including structured storage areas used for recording product-related information, prompts, and model outputs.

The term “retrieve” refers to the operation of reading or acquiring data from the structured storage area based on one or more identifiers, keys, or query conditions.

The term “generative AI model” refers to a machine-implemented information processing model, such as a neural network-based language model, that generates output content, including natural language text, based on input data such as prompt sentences.

The term “prompt sentence” refers to an instruction sentence or series of instruction sentences provided as input to a generative AI model, specifying a desired output type, style, or content, and optionally incorporating product-related information or user state information.

The term “inquiry data” refers to data transmitted from the server to the generative AI model, including at least one prompt sentence and optionally additional parameters or context used to control the behavior of the generative AI model.

The term “response data” refers to data returned from the generative AI model to the server in response to inquiry data, including at least text generated by the model such as recommendation information or advertising information.

The term “recommendation information” refers to generated information that suggests products, product categories, features, trends, or actions to a user, based on product-related information and optionally user state or usage history.

The term “advertising information” refers to generated promotional content intended to introduce, explain, or encourage interest in a product or service, including but not limited to conversational, narrative, or comic-style content.

The term “display data” refers to data generated by the server that specifies content and layout for presentation on the terminal, including recommendation information, advertising information, and associated product-related information.

The term “natural language processing” refers to a type of computational processing that analyzes, transforms, or interprets human language text, including operations such as tokenization, parsing, classification, extraction, or semantic analysis.

The term “preprocessing” refers to operations performed on product-related information or prompt sentences prior to submission to the generative AI model, such as normalization, segmentation, formatting, or enrichment with additional context.

The term “emotional state” refers to a condition indicative of a user's affective response, such as satisfaction, interest, boredom, confusion, or frustration, inferred or detected from explicit input, behavioral signals, or other sensor data.

The term “reaction state” refers to a condition indicative of a user's behavioral reaction to displayed information, such as clicking, scrolling, dismissing, ignoring, or revisiting content, measured or inferred by monitoring user interactions with the terminal.

The term “usage history information” refers to information that records past interactions or behaviors of the user in relation to the system, such as previously viewed products, clicked items, prior prompts, or prior responses.

The term “presentation format” refers to a manner in which information is visually or otherwise rendered to the user on the terminal, including arrangement, ordering, style, emphasis, and media type of displayed content.

The term “comic format” refers to a structured representation of advertising or recommendation information in a style resembling sequential art, including panels, scenes, dialogues, or captions, suitable for presentation as a graphical or storyboard-like sequence.

The term “narrative format” refers to a structured representation of advertising or recommendation information in the form of a story or sequence of events, including characters, plot, and dialogue, presented as continuous text or segmented narrative units.

The term “conversational advertising information” refers to advertising information structured in a dialogue-like or interactive style, such as question-and-answer exchanges, chat-style messages, or simulated conversations between entities.

The term “user” refers to a human operator who interacts with the system via the terminal, inputs product-related information, and receives and views recommendation or advertising information generated by the system.

The term “change the prompt sentence” refers to modifying the content, structure, parameters, or additional instructions of a prompt sentence so as to alter how the generative AI model processes input and generates output, even when the underlying product-related information is identical.

The term “optimize” refers to adjusting the content, structure, or presentation of recommendation information or advertising information to improve one or more performance metrics, such as relevance, engagement, click-through rate, or user satisfaction.

The term “mutually different” refers to outputs that are distinct in at least one aspect of content, structure, style, or emphasis, such that they provide materially different recommendation or advertising variations for the same product-related information.

The term “control” refers to causing a hardware or software component to perform specified operations by executing instructions on the processor.

The server implements the present invention by executing a stored program on at least one processor, in cooperation with one or more terminals operated by users. The server comprises hardware resources including a central processing unit, a main memory, a non-transitory storage device, and a network interface. The server executes server-side software such as an operating system, an application framework, a database management system, and a generative AI client module. The terminal comprises a display unit, an input unit, a communication unit, and a browser application or native application capable of rendering a user interface and communicating with the server over a network.

The server uses a database management system, such as a relational database engine, to implement a structured storage area. The server stores product-related information, prompt sentences, user state information, and generative AI outputs in separate but related data structures, such as normalized tables. For example, the server maintains a product table that stores product-related information as character data, a prompt table that stores prompt sentences and associated parameters, a user state table that stores emotional state and reaction state information, and a recommendation table that stores recommendation information or advertising information generated by a generative AI model. By structuring the data in this way, the server enables efficient indexing, retrieval, and update operations that improve the throughput and latency of the overall system.

The terminal presents an information input screen on a display device using a browser application or native application framework. The terminal renders input fields for product-related information, such as a text field for a product name and a larger text area for a product description. The user operates the input unit, such as a keyboard or touch panel, to input product-related information as character data. The user may input, for example, text such as “latest smartphone” or “a 15-inch lightweight laptop suitable for business use, with long battery life and fast SSD storage.” The terminal acquires this character data from the user interface and encapsulates it into communication data together with metadata such as a user identifier, a timestamp, and a session identifier.

The terminal transmits the communication data to the server via a communication network using a secure transport protocol. The communication data is formatted according to a predefined application protocol, and may be encoded in a structured format suitable for parsing at the server. The terminal, by offloading processing to the server and using lightweight request messages, reduces its own computational load and allows the server to centralize intensive processing operations such as natural language processing and interaction with the generative AI model.

The server receives the communication data from the terminal through a network interface and a web server module. The server parses the communication data to extract the product-related information and associated metadata. The server validates the received product-related information, for example by checking length constraints, allowed character sets, and required fields. The server then stores the validated product-related information in the structured storage area, associating it with identifiers such as a product identifier and a user identifier. The server uses indexing on columns such as product identifier and user identifier to accelerate subsequent retrieval operations.

The server applies natural language processing to the stored product-related information using a language processing library or module. The server tokenizes the character data into word units or subword units, normalizes the text (for example, by lowercasing, removing control characters, and normalizing Unicode), and optionally performs part-of-speech tagging or dependency parsing. The server extracts features such as key phrases, product attributes, sentiment scores, and domain-specific terms. The server stores these features as structured fields in the database, for example, a feature table that links product identifiers to extracted key phrases and attribute-value pairs. By converting unstructured product descriptions into a more structured feature representation, the server reduces the complexity of later prompt construction and enables more targeted interaction with the generative AI model.

The server constructs a prompt sentence based on both the original product-related information and the derived features. The server uses a prompt generation module that combines: (a) a template portion specifying the desired output behavior of the generative AI model, (b) an insertion of the product-related information or a summary generated by the natural language processing module, and (c) conditioning information such as an intended output format, a target language, and style constraints. The server records the constructed prompt sentence in the prompt table, together with metadata such as a version identifier, a reference to the product identifier, and the type of requested output (for example, “trend analysis,” “conversational advertising,” or “comic narrative”).

The server, in one embodiment, generates a prompt sentence such as:

“Based on the following product description: ‘latest smartphone’, please describe current market trends, popular features, and related product categories that would interest potential customers. Answer in English and structure the answer as bullet points.”

The server, in another embodiment, generates a prompt sentence such as:

“Given the following product description: ‘a 15-inch lightweight laptop suitable for business use, with long battery life and fast SSD storage’, please suggest 5 recommendation messages that could be shown to customers, and explain which key specifications should be emphasized in a product listing. Provide the output as short paragraphs for each recommendation.”

The server, in a further embodiment oriented to creative advertising, generates a prompt sentence such as:

“Create a short comic-style scenario that advertises the following product: ‘latest smartphone’. The scenario should consist of 4 scenes with dialogues between a salesperson and a customer, highlighting camera performance, battery life, and design. Output the scenes in numbered order.”

The server, by varying the templates and control phrases in these prompt sentences, can systematically obtain diverse outputs even when the underlying product-related information is identical. The server records, for each prompt sentence, which template was used and which user or usage context triggered the prompt, thereby enabling systematic analysis and optimization of prompt strategies.

The server interacts with a generative AI model implemented as a neural network architecture deployed on a separate computing cluster or attached accelerator. The generative AI model includes an encoder-decoder or decoder-only transformer architecture with multiple layers of self-attention and feed-forward networks. The model uses learned word embeddings, positional encodings, and layer normalization to process sequences of tokens derived from the prompt sentence. The server sends tokenized representations of the prompt sentence to the generative AI model using an inference API, specifying parameters such as maximum output length, temperature, and sampling strategy. The generative AI model, during training, has been optimized using a loss function, such as a cross-entropy loss between predicted token distributions and ground-truth target tokens, and its parameters have been updated using stochastic gradient descent or a variant thereof. The server can store configuration information describing which model version, parameter set, and decoding strategy are used for each interaction.

The server, by explicitly controlling decoding parameters (for example, temperature, top-k or top-p sampling thresholds), can influence the diversity and determinism of the outputs. The server sets different decoding parameters for different prompt sentence types, for example using a higher temperature and wider sampling for creative narrative outputs and a lower temperature for factual or trend-focused outputs. This configuration improves both the relevance and diversity of generated content without requiring separate models.

The server receives response data from the generative AI model that includes generated text corresponding to the tokens predicted in response to the prompt sentence. The server decodes the token sequences into character data and performs post-processing steps such as trimming, splitting into sections, and verifying basic structural requirements (for example, verifying that a requested number of scenes or bullet points was produced). The server may apply additional natural language processing to extract key elements, such as recommended categories, feature highlights, or narrative segments. The server stores the response text and extracted structure in the recommendation table, thereby enabling caching and reuse of previously generated outputs, as well as offline evaluation.

The server acquires user state information, such as emotional state and reaction state, using explicit and implicit signals. The terminal may present reaction buttons or sliders allowing the user to indicate satisfaction, interest level, or relevance level. The terminal also reports behavioral signals, such as dwell time on a section, scrolling patterns, click-through events on recommended items, and whether the user dismisses or expands certain content. The server aggregates these signals and applies rule-based or model-based classification to derive an emotional state label (for example, “high interest,” “low interest,” “confused,” “satisfied”) and a reaction state label (for example, “engaged,” “ignored,” “clicked-through”). The server stores these labels in the user state table with references to the corresponding prompts and recommendations.

The server uses the stored user state information as a parameter in the next prompt construction. For example, when the user's emotional state indicates confusion, the server generates a prompt sentence that requests simpler, more explanatory content, such as:

“The previous explanation seems to have confused the customer. Based on the product description: ‘latest smartphone’, please re-explain the main benefits in simple language suitable for a beginner, using short sentences and avoiding technical jargon.”

When the user's emotional state indicates high interest but low click-through on concrete items, the server generates a prompt sentence that includes more specific call-to-action suggestions:

“The customer is highly interested but has not clicked any product links. Based on the product description: ‘a 15-inch lightweight laptop suitable for business use, with long battery life and fast SSD storage’, please generate 3 concise call-to-action phrases and emphasize unique selling points that distinguish this product from typical competitors.”

By systematically incorporating user state into prompt sentences, the server moves beyond static template generation and implements a feedback-driven adaptive content generation loop. This leads to technically improved utilization of the generative AI model because the server continually refines the prompts in a manner that reduces irrelevant output and increases match with observed user behavior. As a result, the server reduces the number of model calls needed to obtain effective content, which saves computational resources and reduces network traffic between the server and the generative AI model.

The server generates display data that arranges the recommendation or advertising information for presentation on the terminal. The server maps elements of the generated text, such as bullet points, scenes, and conversation lines, into layout structures such as cards, panels, or chat bubbles. The server selects a presentation format based on the type of generated content and the user state. For example, for conversational advertising information, the server formats the text into alternating speaker turns, while for comic-style content, the server segments the text into scenes and associates each scene with a separate frame index. The server may include additional control tags in the display data to instruct the terminal to animate certain elements or to highlight keywords. By computing a compact representation of the layout on the server side, the system reduces the processing burden on the terminal and standardizes rendering logic across different device types.

The terminal receives the display data and interprets layout directives to render the content. The terminal updates its user interface without reloading the entire application state, thereby reducing perceived latency. The terminal may also prefetch additional resources, such as images or icons, based on identifiers contained in the display data. This client-server division of labor improves responsiveness and reduces redundant data transmission, resulting in a reduction of communication load across the network.

The server, by storing all interactions between prompt sentences, user state information, and model outputs in the structured storage area, can analyze aggregate performance of different prompt strategies. The server may periodically execute background processes that compute metrics such as engagement rate per prompt template, average number of model calls per successful engagement, and latency per model interaction. The server uses these metrics to adjust default template choices, output length constraints, and sampling parameters. Because these adjustments are made at the level of the server's control logic rather than manually by human operators, the system automatically improves its internal configuration over time, leading to a measurable improvement in throughput, latency, and accuracy of content matching.

The server, in one embodiment, uses a multi-stage prompt generation algorithm. In a first stage, the server generates a base prompt sentence based solely on product-related information and extracted features. In a second stage, the server incorporates user state and usage history information, such as previously viewed categories or previously effective prompts for similar products. In a third stage, the server optimizes the prompt length and structure by truncating low-importance details and emphasizing key attributes, using a scoring function that favors clarity and specificity. This multi-stage approach provides a technical improvement because it leads to more compact and targeted prompt sentences, which in turn reduce input sequence length for the generative AI model and lower the computational cost of inference.

The server, in another embodiment, uses a distinct configuration to generate comic-style or narrative-format advertising information. The server includes explicit instructions in the prompt sentence about structure, such as the number of scenes, presence of dialogue tags, and narrative perspective. The server applies a structural validator to the model output, checking for compliance with requested structure (for example, verifying that exactly four scenes are present and that speaker labels are properly formatted). If the output does not satisfy structural constraints, the server either generates a revised prompt sentence or applies a transformation to correct the structure. This structured validation and correction step is a technical control mechanism that ensures the generative AI output can be reliably mapped into the user interface components without manual editing.

The server, in yet another embodiment, allows multiple prompt sentences to be generated for the same product-related information and user state, in order to perform parallel exploration of content variations. The server generates several prompt sentences that differ only in phrasing, emphasis, or decoding parameters, submits each to the generative AI model, and then uses a ranking module to select the most promising outputs based on heuristic criteria such as keyword coverage, length, and novelty relative to past outputs. The server records this selection process and reuses successful prompt configurations for similar future cases. This mechanism improves computational efficiency by converging toward high-performing prompt strategies and avoiding repeated generation of low-quality outputs.

The server, across all embodiments, implements a data flow in which product-related information, prompt sentences, user state information, and generative AI outputs are all represented as entries in structured data structures and are linked by identifiers. This representation allows the server to perform complex queries, such as retrieving all prompts that led to high-engagement outputs for a particular product attribute, or all outputs that performed poorly for a given user segment. Such queries reveal patterns that can be used to refine algorithms and configuration settings. Because these refinements are based on data accessible only through the structured storage and computational capabilities of the system, they represent an improvement in computer-based data management and algorithmic control rather than a mere automation of human judgment.

The user, in practice, experiences the system as a dynamic and adaptive recommendation and advertising environment. The user simply inputs product-related information and observes recommendation or advertising information that evolves in style and content as the user interacts with it. However, at the technical level, the server manages a sophisticated pipeline of structured storage, natural language processing, prompt sentence generation, generative AI model control, user state estimation, and presentation optimization. This pipeline improves the operation of the server as a computing machine by reducing redundant computation, organizing data for efficient retrieval and analysis, and producing higher-quality outputs with fewer iterations, thereby achieving concrete technical effects such as improved processing speed, improved relevance accuracy, reduced communication overhead, and better utilization of model computation resources.

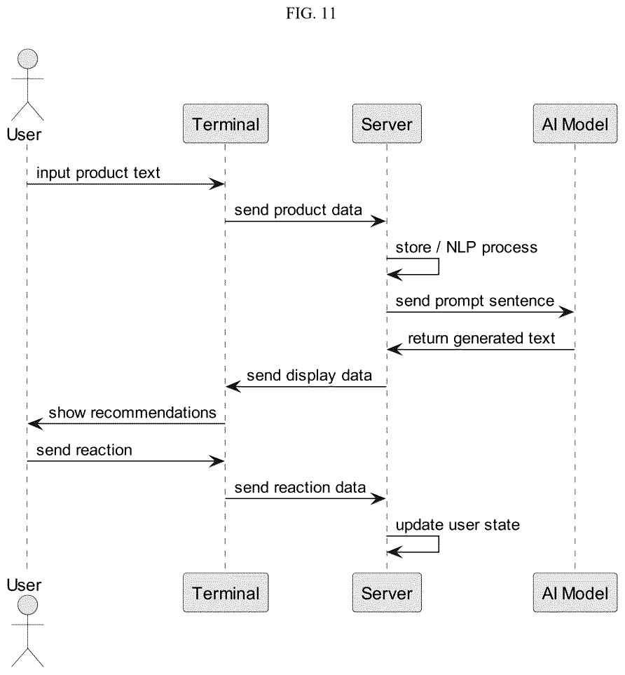

The following describes the processing flow using FIG. 11.

### Step 1

User operates the terminal to open an application or web page and view an information input screen. User inputs product-related information as character data, such as a product name and description, for example, “latest smartphone” or “a 15-inch lightweight laptop suitable for business use, with long battery life and fast SSD storage.” The input of this step is the user's keystrokes or touch interactions, and the output is a text string captured in the terminal's input fields.

### Step 2

Terminal acquires the text string from the input fields and packages it into communication data together with metadata such as a user identifier, a timestamp, and a session identifier. Terminal performs a data formatting operation in which it maps the text string and metadata into a structured message according to a predetermined schema. The input of this step is the raw character data and local metadata, and the output is a structured communication message ready for transmission.

### Step 3

Terminal transmits the structured communication message to the server over a network using a secure communication protocol. Terminal converts the structured message into a network packet sequence and sends the packets via a communication interface. The input of this step is the structured communication message, and the output is a series of network packets delivered to the server's network interface.

### Step 4

Server receives the network packets via a network interface and reconstructs the structured communication message. Server passes the reconstructed message to an application layer, where the message is parsed to extract product-related information and associated metadata. Server performs validation checks, such as verifying that the product-related information is not empty and that it does not exceed length limits. The input of this step is the network packet sequence, and the output is a validated product-related information record in memory.

### Step 5

Server stores the validated product-related information and metadata into a structured storage area, such as a relational database. Server executes a data insertion operation that maps fields from the in-memory record into corresponding columns of a product table. Server creates or updates indexes to allow efficient future retrieval by product identifier or user identifier. The input of this step is the in-memory record of product-related information, and the output is a persistent database record with a unique product identifier.

### Step 6

Server retrieves the stored product-related information from the structured storage area for analysis. Server issues a database query using the product identifier or user identifier, and the database returns the corresponding product description and metadata. Server loads these values into memory for further processing. The input of this step is the identifier used in the query, and the output is a retrieved set of fields containing the product description and associated metadata.

### Step 7

Server performs natural language processing on the retrieved product-related information. Server tokenizes the text into tokens, normalizes the tokens (such as lowercasing and Unicode normalization), and optionally performs part-of-speech tagging or key phrase extraction. Server calculates feature values such as sentiment scores, domain-specific keywords, or attribute-value pairs. The input of this step is the raw product description text, and the output is a structured feature set representing linguistic and semantic properties of the text.

### Step 8

Server constructs a prompt sentence based on the raw product description and the structured feature set. Server selects a prompt template according to a desired output type, such as recommendation information, conversational advertising, or comic-style content. Server fills template placeholders with segments of the product description and with key features, and may append instructions regarding style, language, and output structure. The input of this step is the product description and feature set, and the output is a complete prompt sentence string to be supplied to a generative AI model.

### Step 9

Server reads user state information, such as emotional state and reaction state, from a user state table or a recent interaction log. Server evaluates the user state to determine whether previous content was too complex, insufficiently engaging, or highly successful. Based on this evaluation, server adjusts the prompt sentence by adding clarifying instructions, changing tone, or altering the level of detail. The input of this step is the original prompt sentence and user state information, and the output is a modified prompt sentence that is conditioned on the user's emotional or reaction state.

### Step 10

Server records the final prompt sentence and its associated metadata, including product identifier, user identifier, and user state, into a prompt table in the structured storage area. Server performs a data insertion operation and assigns a unique prompt identifier. The input of this step is the final prompt sentence and its context, and the output is a persistent prompt record linked to the product and user records.

### Step 11

Server converts the prompt sentence into a format suitable for the generative AI model, such as a token sequence, and constructs inquiry data including the prompt sentence and model control parameters like maximum output length and sampling temperature. Server calls a generative AI model inference API over a communication channel, transmitting the inquiry data to the model host system. The input of this step is the prompt sentence and model configuration parameters, and the output is a request message sent to the generative AI model.

### Step 12

Server receives response data from the generative AI model, which includes generated token sequences. Server decodes the tokens into character data and reconstructs one or more text outputs, such as recommendation information or advertising information. Server may split the text into sections, such as bullet points, scenes, or conversational turns, according to the structure requested in the prompt sentence. The input of this step is the model's token-based response, and the output is a structured textual representation of the generated content.

### Step 13

Server analyzes the generated text for structural and content compliance. Server verifies whether the generated text satisfies requested constraints, such as the number of bullet points or scenes, and whether key product attributes are present. If the text does not satisfy constraints, server may flag the output or trigger regeneration with an adjusted prompt sentence. The input of this step is the structured textual representation, and the output is either a validated, constraint-compliant text structure or a decision to perform further generation.

### Step 14

Server stores the validated generated content in a recommendation table or advertising table within the structured storage area. Server associates each generated content entry with references to the corresponding prompt identifier, product identifier, and user identifier. The input of this step is the validated structured textual content, and the output is a persistent record of recommendation or advertising information linked to its generation context.

### Step 15

Server constructs display data based on the structured content and the intended presentation format. Server maps text segments to layout components such as cards, chat bubbles, or comic panels, and assigns ordering, labels, and optional emphasis markers. Server serializes this layout structure into a format consumable by the terminal user interface. The input of this step is the structured content and layout rules, and the output is a display data object describing how the information should be rendered.

### Step 16

Server transmits the display data to the terminal over the network. Server encapsulates the display data into response messages and sends them via the network interface using an application-level protocol. The input of this step is the display data object in memory, and the output is a sequence of network packets carrying the display instructions to the terminal.

### Step 17

Terminal receives the network packets and reconstructs the display data. Terminal parses the layout structure and updates the user interface accordingly, creating or updating visual components such as text blocks, panels, and interactive elements. The input of this step is the transmitted display data, and the output is a rendered user interface on the display unit showing recommendation information or advertising information associated with the product-related information.

### Step 18

User views the rendered content on the terminal and interacts with it, for example by scrolling, clicking recommended items, selecting reaction buttons, or closing sections. User's actions generate new interaction events, such as clicks and dwell times, which the terminal records as reaction indicators. The input of this step is the displayed user interface, and the output is a set of user interaction signals captured by the terminal.

### Step 19

Terminal aggregates the user interaction signals into user reaction data, possibly including explicit ratings, satisfaction indicators, and behavioral metrics. Terminal sends this user reaction data back to the server as communication data. The input of this step is the raw interaction events, and the output is structured user reaction data transmitted to the server.

### Step 20

Server receives the user reaction data and updates user state information. Server computes derived metrics, such as engagement scores, click-through rates, or confusion indicators, and classifies the user's emotional state and reaction state based on predefined rules or trained classifiers. Server stores the updated state in the user state table, associated with the relevant product and prompt identifiers. The input of this step is the structured user reaction data, and the output is an updated user state record that will be used as an input when constructing subsequent prompt sentences.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented recommendation and advertising systems rely heavily on manually designed rules, static templates, or fixed decision trees to generate related product suggestions and advertisements. In such systems, a processor typically selects items based on predefined attribute matching or collaborative filtering, and then inserts the selected items into rigid display layouts. This architecture imposes several technical limitations.

First, the processor must execute complex, hand-crafted logic to handle diverse user queries and product descriptions, leading to increased code complexity and maintenance cost. When the variety of product information and user intents grows, the number of conditional branches and heuristic rules in the software stack increases, which in turn increases processor load, memory usage, and the likelihood of inconsistent outputs. As a result, the system cannot efficiently adapt to new product domains or new user interaction patterns without substantial reprogramming and redeployment.

Second, in many existing systems, the generation of natural language content, such as conversational advertisements or explanation texts for recommended items, is separated from the core data processing pipeline. The processor often retrieves prewritten phrases or sentence fragments from a datastore and stitches them together. This causes repetitive and unnatural outputs and prevents the system from flexibly tailoring content to user context or emotional state. The lack of an integrated mechanism to translate arbitrary product information into high-quality natural language output forces the system to operate with limited expressiveness and reduced user engagement.

Third, even when a generative AI model is used, it is frequently invoked in an ad hoc manner, without a structured prompt generation mechanism or a feedback loop between user inputs, prompts, and model outputs. In such a configuration, the processor may send unstructured or inconsistent requests to the generative AI model, resulting in unstable response formats, unpredictable latency in downstream parsing, and increased computational overhead to normalize outputs. Furthermore, conventional systems often do not maintain an efficient mapping between input product information, generated prompt sentences, and model responses. This prevents effective reuse of past results and leads to unnecessary calls to the generative AI model, thereby increasing processing time, network load, and cost.

Fourth, known systems typically do not provide a unified control mechanism that dynamically adjusts prompt sentences and output structures based on user emotional state or user behavior history. As a result, the processor cannot algorithmically select appropriate generation parameters or content styles at runtime, and the system fails to optimize the generated related product information or advertisement content for different user states. This lack of dynamic adaptability degrades the overall effectiveness of the recommendation pipeline and reduces the efficiency with which the processor utilizes computational resources for content generation and presentation.

Accordingly, there is a need for an improved computer-implemented system and method in which a processor systematically converts arbitrary product information into structured prompt sentences, cooperatively interacts with a generative AI model, and manages the full loop of input, prompt, response, and output transformation. The technical challenge is to design a processor configuration and data flow that (i) reduces the complexity of application logic for generating diverse related product suggestions and advertisement contents, (ii) stabilizes the output format of generative AI responses for efficient machine processing, (iii) reuses prior computation results through a correspondence store between inputs, prompts, and responses, and (iv) dynamically adapts the generation process to user emotional state and user behavior history to improve the efficiency and quality of computer-based recommendation and advertising operations. The present invention addresses these technical problems by providing a server and associated processing steps that integrate prompt generation, generative AI invocation, structured post-processing, and adaptive optimization in a unified architecture.

The specific processing by the specific processing unit 290 of the data processing device 12 in Application Example 1 is realized by the following means.

The present invention provides a server comprising a processor configured to receive product information as input from a terminal device; analyze the product information using natural language processing and perform preprocessing on the product information; generate a prompt sentence by fitting the preprocessed product information into a predetermined template, the prompt sentence instructing a generative AI model to generate related product information or advertisement information; transmit a request including the prompt sentence to an external generative AI model and obtain response data from the generative AI model, the response data including the related product information or the advertisement information; analyze the response data to extract candidates of related products or advertisement contents and structure the extracted candidates as output data in a list format or a dialogue format; adjust the output data according to a user emotional state or a user usage state, format the adjusted output data as display data, and transmit the display data to the terminal device; and store a correspondence among the product information, the prompt sentence, and the response data, and control whether to make an inquiry to the generative AI model for similar input based on the stored correspondence. This enables the server to systematically transform arbitrary product information into machine-parseable prompt sentences, to obtain stable and structured generative AI outputs with reduced application-level logic, to reuse past generation results for similar inputs so as to reduce redundant external model calls and associated processing overhead, and to dynamically optimize the format and content of related product information and advertisement contents according to user emotional state and user behavior history, thereby improving the efficiency, scalability, and quality of computer-implemented recommendation and advertising processing.

The term “product information” refers to data representing attributes of an item or service, including at least a name, category, specification, feature description, usage scenario, or other descriptive text that can be processed by a computing device.

The term “natural language processing” refers to a set of computational techniques executed by a processor to analyze, interpret, or transform human-readable text, including operations such as tokenization, normalization, parsing, part-of-speech tagging, entity recognition, and semantic analysis.

The term “preprocessing” refers to operations performed by a processor on input data prior to subsequent processing, including but not limited to trimming, normalization, format conversion, encoding conversion, filtering, and rearrangement of the data into a form suitable for further computation.

The term “prompt sentence” refers to a machine-readable natural language instruction generated by a processor, which includes the preprocessed product information and directs a generative AI model to perform a specified generation task such as producing related product information or advertisement information.

The term “template” refers to a predefined data structure or text pattern, stored in a memory, that includes one or more placeholders into which variable information, such as preprocessed product information, is inserted by a processor to form a complete prompt sentence.

The term “generative AI model” refers to a machine learning model, implemented for example as a neural network, that receives an input including a prompt sentence and generates new data such as natural language text representing related product information or advertisement information.

The term “external generative AI model” refers to a generative AI model executed on a computing environment separate from the server, which is accessible via a communication network and is invoked by transmitting a request including a prompt sentence from the server.

The term “response data” refers to data returned from the generative AI model to the server in response to a request including a prompt sentence, the data including at least generated natural language text that describes related product information or advertisement information.

The term “related product information” refers to information describing one or more products that are associated with, complementary to, or alternative to a product indicated by the input product information, the association being determined at least in part by the generative AI model.

The term “advertisement information” refers to information intended for presentation to a user to promote a product or service, including natural language content such as descriptions, slogans, dialogues, or narratives, and optionally including structured elements such as tags or layout hints.

The term “candidates of related products” refers to individual product entries identified or derived from response data, each entry including at least an identifier or name of a product and optionally including descriptive text or attributes.

The term “advertisement contents” refers to one or more units of advertising output generated based on response data, each unit including at least natural language text and optionally including structured information for display formatting or interaction control.

The term “output data” refers to data structured by the processor for delivery to a terminal device, the data including at least candidates of related products or advertisement contents arranged in a predetermined representation such as a list format or a dialogue format.

The term “list format” refers to a representation of output data in which multiple items, such as candidates of related products, are arranged as an ordered or unordered collection, for example as numbered entries, bullet points, or array elements.

The term “dialogue format” refers to a representation of output data in which information is structured as an exchange of utterances between two or more parties, such as a simulated conversation between a system and a user.

The term “user emotional state” refers to a condition of a user's affect or sentiment, such as being positive, neutral, or negative, which is estimated by the processor based on input signals, including but not limited to user interactions, textual expressions, or sensor data.

The term “user usage state” refers to contextual information about how a user currently interacts with a system, including factors such as session type, current screen, interaction history in the session, elapsed time, device type, or network condition.

The term “user behavior history” refers to recorded data indicating past actions of a user, including at least prior searches, clicks, purchases, content views, and interaction patterns with recommended items or advertisements.

The term “display data” refers to data formatted by the processor in a structure suitable for rendering by a terminal device, including at least the arrangement, style hints, and content segments that define how related product information or advertisement contents are visually or audibly presented.

The term “terminal device” refers to an end-user computing apparatus capable of communicating with the server over a network, including but not limited to a smartphone, tablet, personal computer, or other display-equipped device.

The term “correspondence” refers to an association stored in a memory between multiple pieces of data, including at least the input product information, the generated prompt sentence, and the response data obtained from the generative AI model.

The term “similar input” refers to product information that is determined by the processor to be same as or analogous to previously received product information, based on at least one similarity measure such as lexical similarity, semantic similarity, or normalized attribute matching.

The term “inquiry to the generative AI model” refers to a processing operation in which the processor generates and transmits a request including a prompt sentence to the generative AI model and waits for and receives corresponding response data.

The term “control whether to make an inquiry” refers to a decision process performed by the processor to determine, based on stored correspondence and similarity between current and past inputs, whether to reuse existing response data or to transmit a new request to the generative AI model.

The server implements the invention using a combination of general-purpose computing hardware and specialized software components.

The server is realized on a computing platform such as a rack-mounted computer or a virtual machine instance in a data center, equipped with at least one central processing unit, a main memory, a non-volatile storage device, and a network interface. The server executes an operating system such as a general-purpose server operating system, and runs application software including a web server component, an application framework component, and a machine-learning client library component. The server communicates with at least one terminal over a network such as the Internet using a communication protocol such as HTTPS.

The terminal is realized as a user-side computing apparatus such as a smartphone, a tablet, or a personal computer. The terminal executes client software such as a web browser or a native application. The terminal provides an input interface and a display interface. The user operates the terminal to input product information and to view related product information or advertisement contents that are generated based on processing performed by the server and an external generative AI model.

The user operates the terminal to start an interaction session with the server. The user launches, for example, a web browser or a shopping application and accesses a content presentation screen provided by the server. The user inputs product information such as a product name, a usage scenario, a price range, or desired features into a text input field rendered on the terminal. The terminal converts the user input into digital text data and sends it to the server as part of a formatted network request.

The server receives the product information as input from the terminal and stores the received data in a memory-resident data structure, for example a string buffer or a structured object that includes fields for the raw text, a timestamp, and a session identifier. The server uses a natural language processing library to perform preprocessing on the product information. The server performs tokenization, normalization, and encoding conversion. For example, the server converts all text to a unified character encoding, removes control characters, and standardizes spacing. The server may also perform language detection and basic syntactic parsing to identify key phrases corresponding to product attributes.

The server generates a prompt sentence based on a template stored in a configuration repository. The server maintains multiple prompt templates in a structured format. Each template is a sequence of text including placeholders. The server selects an appropriate template according to a content generation mode, such as a mode for related product recommendation, a mode for conversational advertisement, or a mode for comic-style advertisement content. The server substitutes the preprocessed product information into the placeholders of the selected template using string formatting operations. As a result, the server forms a complete prompt sentence that is configured to instruct a generative AI model to perform a specified generation task.

The server, for example, generates a prompt sentence such as:

“The user entered the product name ‘Bluetooth earphones’. Please use a generative AI model to propose three related products that the user might be interested in, and provide a brief description for each product. Return the result as a numbered list.”

Alternatively, when conversational advertisement content is required, the server may generate a prompt sentence such as:

“The user provided the following product information: ‘Over-ear Bluetooth headphones with comfortable cushions, mainly for use during commuting and remote work.’ Please generate a conversational advertisement script between a system and a user that naturally introduces three recommended products related to this information.”

For a comic-style advertisement, the server may generate a prompt sentence such as:

“The user provided the following product information: ‘4K smart TV, 55 inches, mainly for watching movies and sports.’ Please generate a scenario for a multi-panel comic that advertises this product and two related accessories, including character dialogues and scene descriptions.”

The server configures a request to an external generative AI model executing on a remote computing environment. The external generative AI model is implemented as a trained neural network, for example a transformer-based language model with multiple attention layers, feed-forward layers, and layer normalization operations. The server includes in the request the prompt sentence, a model identifier, and generation control parameters such as temperature, maximum output length, sampling strategy, and formatting constraints. The server thereby controls, at a low level, how the neural network executes token-by-token generation to produce output text.

The server invokes the external generative AI model by sending the prompt sentence and the parameters over a secure communication channel to a remote model-serving infrastructure that includes one or more processors, such as graphical processing units or specialized accelerators. The generative AI model processes the prompt sentence by mapping each token to an embedding vector, applying multi-head self-attention and feed-forward transformations across multiple layers, and generating a sequence of output token probability distributions. The model selects output tokens according to the control parameters specified by the server. The external environment returns the generated text as response data in a structured response format.

The server receives the response data and parses the generated text. The server uses pattern-based parsing rules and, where applicable, structured generation guidelines included in the prompt sentence to separate the response into discrete items. For related product information, the server identifies each recommended item as a candidate of a related product and extracts a product name and an explanatory text. The server represents each candidate in a data structure including fields for a product label, a short description, and optional attributes such as a category or use case phrase extracted using natural language processing.

The server may access a product catalog database stored in a data storage device. The database contains structured records for products, including identifiers, metadata, images, and pricing data. The server performs a database query for each candidate of a related product to align the generated product name with an actual record. The server may apply string similarity metrics or embedding-based similarity computation to map generated labels to existing products. The server thereby enriches the AI-generated candidates with technical data, images, and pricing information retrieved from the database.

The server structures the enriched candidates or advertisement contents as output data in a representation compatible with the terminal. The server may use a list format, in which each item is placed into an array-like structure containing textual fields and display hints, or a dialogue format, in which the server labels each utterance as belonging to a system side or a user side and arranges them in temporal order. The server additionally computes layout metadata such as ordering, grouping, and emphasis flags. The server stores the output data in memory and transforms it into display data, including, for example, layout tags or simple styling indicators, without requiring complex rendering logic on the terminal.

The server adjusts the display data according to a user emotional state or a user usage state. The server estimates the user emotional state based on prior interaction logs, sentiment analysis of user-submitted text, or engagement metrics such as dwell time and click patterns. The server maps the estimated emotional state to content-style parameters, such as tone (more formal or casual), level of detail, and aggressiveness of recommendations. The server modifies the prompt sentence generation rules or post-processing rules so that the final display data reflects these style parameters. For example, when the user emotional state is detected as negative or frustrated, the server may select a template that generates more supportive language and fewer aggressive sales prompts.

The server records correspondences among the input product information, the generated prompt sentence, and the response data in a persistent storage structure such as a key-value store or a relational database. The server uses a hashed or embedded representation of the product information as a key and stores associated prompt sentences, generation parameters, and resulting response data as the value. When new product information is received, the server computes a similarity measure between the new input and stored keys using lexical or embedding-based comparison. If the server determines that the new input is similar to a previously processed input within a threshold, the server retrieves the stored response data and reuses it as the basis for output data, instead of transmitting a new request to the generative AI model. This reuse mechanism reduces communication overhead, lowers latency, and decreases the number of times the external generative AI model must be invoked, thereby improving computational efficiency.

The server configures the overall architecture so that the transformation from product information to prompt sentence to structured response and finally to display data can be performed using reduced application-level conditional logic. Instead of maintaining a large number of domain-specific rules, the server centralizes variation handling in the prompt templates and generation parameters. The server thereby reduces the complexity of conditional branches executed by the processor, which in turn reduces instruction cache thrashing and improves runtime performance. The server also ensures that responses from the generative AI model adhere to predictable patterns by specifying in the prompt sentence the expected output format, such as numbered lists, labeled JSON-like segments, or dialogue turns. Because the server instructs the model to produce consistent structure, the amount of post-processing needed to normalize outputs is reduced. This decrease in parsing complexity reduces CPU cycles required for parsing and error handling.

The server implements an error-feedback mechanism for the generative AI interaction. If parsing of response data fails or produces inconsistent structures, the server detects such inconsistency using validation rules and, if necessary, adjusts the prompt template or generation parameters for subsequent requests. Over time, the server refines prompt sentences and parameter values such that the external generative AI model produces more stable outputs. This adaptive behavior is not a mere automation of human drafting but rather an improvement to the way the computing system itself organizes and executes text-generation tasks to achieve higher reliability and lower computational overhead.

The server may employ different implementations of the external generative AI model. In one embodiment, the external generative AI model is a large-scale transformer trained on a corpus including product descriptions, dialogue data, and advertisement texts. The training procedure adopts a loss function that measures the cross-entropy between predicted tokens and target tokens, and uses gradient-based optimization with mini-batches. Model parameters are updated by backpropagation, and regularization techniques such as dropout and layer normalization are applied. In another embodiment, the generative AI model is fine-tuned with domain-specific data to better align with product and advertising domains, enabling improved accuracy of related product suggestion and more coherent advertisement scripts.

The server utilizes specific generation parameters to further control computational behavior. For example, the server may set a low temperature parameter to encourage deterministic outputs and reduce the variance in generated content, leading to a more efficient post-processing pipeline that can assume a narrower distribution of output patterns. The server may limit maximum token counts to bound response size and avoid overly long outputs that increase parsing time and network transmission time. The server may adjust nucleus sampling thresholds to balance diversity and consistency of generated content. By precisely controlling these parameters, the server directly influences the computational load on both the external generative AI model and the local parsing modules.

The terminal receives display data from the server and renders it on a display device. The terminal may use a user interface framework to present lists, dialogues, or comic-style layouts based on the structural hints included in the display data. The terminal processes only lightweight formatting logic, because the server has already structured the data in accordance with the required format. This division of labor permits the terminal to operate efficiently, even on limited hardware resources.

The user reviews the displayed related product information or advertisement contents and may perform further actions such as selecting a recommended item, requesting more information, or refining product information. The server captures these actions as behavior history data and uses them in subsequent processing to adjust prompt generation and content selection, thereby closing a feedback loop that optimizes both system performance and output relevance.

The server, by orchestrating these operations, improves computer technology in several concrete aspects. The server reduces the number of distinct application-level rules necessary to support varied product and advertisement domains, thereby decreasing maintenance overhead and processor cycles spent on rule evaluation. The server improves data management by defining specific data structures for product information, prompt sentences, response data, output data, and display data, and by storing correspondences among these entities for reuse. The server reduces communication load by avoiding redundant requests to the external generative AI model through similarity-based reuse of past responses. The server increases processing speed by instructing the generative AI model to generate outputs in constrained, machine-parseable formats, which minimizes complex parsing and error handling. The server also improves content accuracy and responsiveness by dynamic adjustment of prompt templates and parameters based on user emotional state and behavior history.

The server thus does not merely automate human drafting of related product recommendations or advertisements. Instead, the server reconfigures how the computing system handles text generation pipelines, including prompt construction, neural network invocation, structured parsing, and adaptive reuse, in a way that yields measurable technical benefits such as reduced computation, reduced communication, improved predictability of outputs, and more efficient use of memory and processing resources. The combination of these features enables the system to implement the claimed invention in a manner that other practitioners can reproduce and adapt to various hardware and software environments.

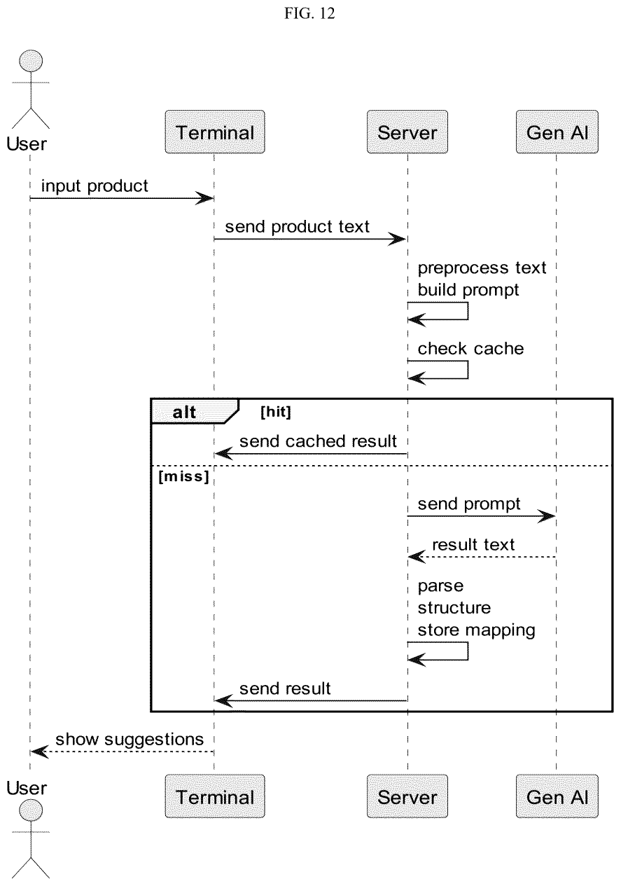

The following describes the processing flow using FIG. 12.

### Step 1

The user operates the terminal to input product information. The user launches a browser or application on the terminal, focuses an input field, and types a product name or description such as “Bluetooth earphones with noise cancelling.” The input of this step is raw keystrokes or touch events, and the output is a text string held in the terminal's memory. The terminal converts the user's character inputs into a Unicode text buffer and associates the buffer with a user session.

### Step 2

The terminal sends the product information to the server. The terminal takes the text buffer as input and serializes it into a request payload, for example as JSON containing a field “query.” The terminal performs data formatting, adds headers, and opens a secure network connection to the server. The output of this step is a network packet stream containing the serialized product information and session metadata, transmitted over a communication channel to the server.

### Step 3

The server receives and parses the incoming request. The server takes the network packet stream as input and reconstructs an HTTP request object. The server then reads the request body and applies a JSON parsing routine to extract the product information string and associated parameters such as language or mode. The output of this step is an internal data structure, for example an object with fields for raw product text, session ID, and timestamp, stored in the server's working memory.

### Step 4

The server performs preprocessing on the product information using natural language processing. The server takes the internal object as input, extracts the product text, and applies text normalization (trimming whitespace, converting character encodings, standardizing punctuation) and tokenization. The server may also detect language and extract key tokens such as product type (“earphones”) and feature words (“noise cancelling”). The output of this step is a preprocessed text representation and associated token list, which the server stores in a structured in-memory record.

### Step 5

The server selects a prompt template according to a content generation mode. The server takes as input the preprocessed text and optionally a mode indicator (for example “related products,” “conversational advertisement,” or “comic-style advertisement”). The server performs a lookup in a template repository, retrieving a template string that includes placeholders such as “{PRODUCT_INFO}” and instructions specifying output format. The output of this step is a selected template string and a set of placeholder positions, ready to be combined with the preprocessed product information.

### Step 6

The server generates a prompt sentence by inserting the preprocessed product information into the template. The server takes the template string and the preprocessed text as input, and performs string substitution or formatting operations to replace placeholders with the actual product text. The server may also append explicit format constraints, such as “Return the result as a numbered list.” The output of this step is a complete prompt sentence, for example:

“The user entered the product name ‘Bluetooth earphones’. Please use a generative AI model to propose three related products that the user might be interested in, and provide a brief description for each product. Return the result as a numbered list.”

### Step 7

The server determines whether to reuse a past response or to call the generative AI model. The server takes as input the preprocessed product information and the generated prompt sentence. The server computes a similarity measure between the current product information and previously stored product information keys in a correspondence store, using lexical comparison or vector similarity. If the similarity exceeds a threshold, the server selects a stored response associated with the closest key. If not, the server decides to call the external generative AI model. The output of this step is either a retrieved past response record or a decision flag indicating that a new generative AI request must be created.

### Step 8

The server constructs a request to the external generative AI model when a new generation is required. The server takes the prompt sentence and model control parameters as input (for example, model name, temperature, max tokens, and expected format description). The server builds a structured request object, placing the prompt sentence into the appropriate field and setting parameter values. The server serializes this object into a network-ready payload. The output of this step is a formatted generative AI request packet ready for transmission.

### Step 9

The server transmits the request to the external generative AI model and waits for response. The server takes the serialized payload as input and sends it via a secure network channel to a remote model-serving endpoint. The server performs network I/O operations, manages timeouts, and retries as needed. The output of this step is a received response payload from the generative AI model, typically in a structured format containing generated text.

### Step 10

The server parses the response data from the generative AI model. The server takes the response payload as input, deserializes it, and extracts the generated text content from the designated field. The server then analyzes the text according to the format specified in the prompt sentence, for example by splitting at line breaks or numbering markers to identify separate items. The output of this step is a list of raw generated items, each item typically containing a product name phrase and an explanatory text segment.

### Step 11

The server converts the raw generated items into structured candidates of related products or advertisement contents. The server takes the list of raw items as input and applies pattern-based parsing rules and optional secondary natural language processing. The server separates a main label (for example, “Noise-cancelling Bluetooth earphones”) from a description (for example, “Earphones with active noise cancelling suitable for commuting”), trims extraneous characters, and normalizes spacing. The output of this step is a collection of structured objects, each representing a candidate item with fields such as “title,” “description,” and optional “category.”

### Step 12

The server optionally enriches the structured candidates using a product catalog or content repository. The server takes the candidate objects as input and issues database queries or search operations against a product or content database. The server compares generated titles with stored entries using string similarity or embedding similarity to find matching real-world products or content units. The server then attaches additional attributes such as identifiers, prices, images, and URLs to each candidate. The output of this step is an enhanced list of candidate objects linking generated text to concrete records in the database.

### Step 13

The server determines a user emotional state and user usage state for adaptive output adjustment. The server takes as input session-level data, past interaction logs, sentiment scores derived from user-provided text, and contextual information such as current page type or time-on-page. The server performs statistical analysis or lightweight classification to infer a current emotional state (for example, positive, neutral, or negative) and a usage state (for example, browsing mode or purchase-intent mode). The output of this step is a pair of state indicators that the server passes to a style-adjustment module.

### Step 14

The server adjusts the structured candidates based on the user emotional state and user usage state. The server takes as input the list of candidate objects and the state indicators. The server applies transformation rules to modify descriptive phrases, ordering, and emphasis. For example, when the user state is “frustrated,” the server may soften language and highlight helpful features rather than strong call-to-action phrases. The server may also filter or re-rank candidates based on inferred intent. The output of this step is a refined list of candidate objects whose textual content and ordering are adapted to the user's current state.

### Step 15

The server structures the refined candidates into output data in a list or dialogue format. The server takes the refined candidate objects and the selected presentation mode as input. The server arranges items into a list data structure, assigning indices and grouping information, or constructs a dialogue sequence by assigning speaker roles and turn order to each text segment. The server adds layout hints such as section headers, emphasis flags, or grouping tags. The output of this step is a structured output object that fully defines the content and basic layout to be rendered by the terminal.

### Step 16

The server converts the output object into display data suitable for the terminal and transmits it. The server takes the structured output object as input and serializes it into a response payload for the terminal, including necessary metadata such as language, encoding, and version identifiers. The server optimizes the payload size by removing redundant fields and compressing text if appropriate. The output of this step is a network response stream carrying the display data back to the terminal.

### Step 17

The terminal receives the display data and renders it to the user. The terminal takes the network response stream as input, reconstructs the response object, and parses the structured data. The terminal maps each item or dialogue turn to user interface components such as list items, cards, or chat bubbles. The terminal then draws these components on the screen according to the structural hints included in the display data. The output of this step is a visual presentation of related product information or advertisement contents that the user can view and interact with.

### Step 18

The server records correspondences among the input product information, the prompt sentence, and the response data for future reuse. The server takes as input the original preprocessed product information, the prompt sentence used, and the structured response data (including any enriched candidates). The server computes a key representation of the product information, such as a normalized text string or an embedding vector, and stores this key in association with the prompt sentence and the response data in a correspondence store. The output of this step is an updated correspondence database that the server can reference in later sessions to avoid redundant invocations of the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented advertising generation systems typically apply a text generation model directly to raw product descriptions to output a single advertisement text. Such systems suffer from several technical limitations in the way they process, structure, and control data within the computing environment.

First, existing systems often lack a structured natural language processing pipeline that converts unstructured prompt sentences received from a user terminal into normalized, model-ready data. As a result, the generative processing performed by a language model can be inefficient and unstable, causing unnecessary computation, inconsistent tokenization, and degraded utilization of processing resources in a server environment.

Second, conventional systems generally do not provide a programmatic mechanism at the server side to construct, modify, and manage model-level prompt sentences as explicit control objects. In many cases, the prompt used by the generative model is a simple pass-through of the user's text. This prevents fine-grained control of generation policies (for example, conversation structure, role definition, and output length) and requires repeated manual tuning by an operator, which leads to increased processing time, redundant model calls, and inefficient use of processor and memory resources.

Third, traditional systems are usually not configured to integrate user emotion information as a computational parameter for dynamically controlling both input prompts and generated outputs. In typical implementations, any “emotion-based” adjustments are performed manually by editing text after generation on the client side. This means that emotion-related conditions are not integrated into the server-side generation pipeline, and the server cannot automatically adapt its internal prompt construction and postprocessing stages. Consequently, the system cannot efficiently generate multiple, emotion-adaptive variants of advertisements for the same product information in a controlled and reproducible manner, which results in repeated full regeneration cycles and increased network and computation overhead.

Fourth, most existing systems treat the generated output as a monolithic text string and do not implement a specialized postprocessing stage that enforces a conversation-type structure, such as speaker labels, turn counts, and line formatting. This lack of structured postprocessing forces the user terminal or a human user to perform formatting corrections, which causes duplicated processing, fragmented responsibility between client and server, and inconsistent display behavior across different terminals.

Fifth, in conventional architectures, there is no integrated control loop for receiving updated prompt sentences or additional user constraints from the terminal and systematically regenerating different conversation-type advertisements for the same product information through controlled changes to model-level prompt sentences. Without such a loop, each regeneration behaves as an independent, ad-hoc request, which prevents efficient reuse of extracted and preprocessed product information, increases latency, and imposes unnecessary processing load on the generative model.

Accordingly, there is a need for an improved computer-implemented system and server-side processing method that (i) normalizes and structures prompt sentences containing product information, (ii) programmatically constructs and controls model-level prompt sentences for a generative AI model, (iii) integrates user emotion parameters as first-class control inputs in the generation pipeline, (iv) performs structured postprocessing to enforce conversation-type formatting, and (v) supports iterative regeneration of multiple advertising variants based on the same product information. Such a system would improve the efficiency, controllability, and reliability of generative processing in the server environment, thereby improving the operation of the computer itself when generating conversation-type advertisements.

The specific processing by the specific processing unit 290 of the data processing device 12 in Example 2 is realized by the following means.

The present invention provides a server comprising a processor configured to receive, from a terminal, a prompt sentence including product information, validate existence and length of the prompt sentence, and analyze the prompt sentence to extract the product information; to perform natural language preprocessing on the extracted product information, the natural language preprocessing including at least morphological analysis, tokenization, removal of unnecessary words, and normalization of word forms, and to generate preprocessed data suitable for input to a generative AI model; to generate a model-level prompt sentence including the preprocessed data and an instruction text defining a creation policy of a conversation-type advertisement and roles of dialogue participants, and to input the model-level prompt sentence to the generative AI model to cause the generative AI model to generate conversation-type advertisement text; to perform postprocessing on the generated conversation-type advertisement text, the postprocessing including at least assigning speaker labels, formatting line breaks, checking grammar and notation, and adjusting the conversation-type advertisement text to a predetermined number of dialogue turns or characters, and to generate postprocessed advertisement text; to adjust a writing style, a length, and an appeal content of at least one of the model-level prompt sentence and the postprocessed advertisement text based on an emotion parameter corresponding to an emotional state of a user, and to generate advertisement text adapted to the emotional state of the user; to transmit the generated advertisement text to the terminal and cause the generated advertisement text to be displayed to the user on the terminal; and to receive, from the terminal, a re-input prompt sentence or additional condition from the user, and perform control to repeatedly generate different conversation-type advertisement text for same product information by changing the model-level prompt sentence. This enables the server to perform structured, emotion-aware control of generative processing, to reduce redundant computation and manual post-editing, to efficiently regenerate multiple variants of conversation-type advertisements for the same product information, and thereby to improve the technical performance and resource utilization of the computer system implementing advertisement generation.

The term “system” refers to a combination of one or more computing devices, storage resources, communication interfaces, and software components that cooperate to perform the functions described in this specification.

The term “processor” refers to one or more hardware processing units, such as a central processing unit, graphics processing unit, or other instruction-executing circuitry, configured to execute program code to perform operations on data.

The term “terminal” refers to any user-operated computing device, including but not limited to a mobile device, a tablet device, a desktop device, or a browser-based client, that transmits data to and receives data from the server.

The term “prompt sentence” refers to a text string provided from the terminal to the server, the text string including at least product information and optionally additional instructions or constraints for generating an advertisement.

The term “product information” refers to data describing attributes of an item or service, including at least one of a name, a function, a feature, a specification, a performance characteristic, a usage scenario, or a target customer group.

The term “natural language preprocessing” refers to a series of automated operations applied to text data to convert unstructured text into a normalized representation more suitable for computational processing, such operations including at least one of morphological analysis, tokenization, removal of unnecessary words, and normalization of word forms.

The term “morphological analysis” refers to a process of analyzing a text string into morphemes or word units and annotating or identifying part-of-speech or grammatical roles of such units.

The term “tokenization” refers to a process of segmenting a text string into discrete elements, such as words, subwords, characters, or symbols, that can be individually processed by a computational model.

The term “removal of unnecessary words” refers to a process of identifying and excluding words or tokens, such as function words or common stop words, that are determined to have low relevance for a target processing task.

The term “normalization of word forms” refers to a process of converting different inflected or derived forms of words into a standard or base form, such as a lemma or stem, to reduce variation in text data.

The term “preprocessed data” refers to data obtained by performing natural language preprocessing on original text, the data being structured or encoded so as to be suitable for use as input to a generative AI model.

The term “generative AI model” refers to a trained artificial intelligence model that uses machine learning techniques, such as a neural network or transformer model, to generate new text data based on input data and internal parameters.

The term “model-level prompt sentence” refers to a text string provided as input to the generative AI model, the text string including at least preprocessed data and instruction text that specifies how output text is to be generated.

The term “instruction text” refers to a portion of the model-level prompt sentence that describes a generation policy, including at least one of a desired output format, a role of a speaker, a style of expression, a length constraint, or a content focus.

The term “conversation-type advertisement” refers to advertisement text structured as a dialogue between two or more participants, wherein information about a product or service is communicated through alternating utterances.

The term “conversation-type advertisement text” refers to textual data generated by the generative AI model that represents a conversation-type advertisement and includes multiple dialogue turns by at least two speakers.

The term “postprocessing” refers to a series of operations applied to text generated by the generative AI model to convert raw output into a final form suitable for presentation, such operations including at least assigning speaker labels, formatting line breaks, checking grammar and notation, and adjusting length.

The term “speaker label” refers to a textual identifier, such as “Customer” or “Salesperson,” attached to an utterance in conversation-type advertisement text to indicate which participant is speaking.

The term “line break formatting” refers to a process of inserting, removing, or adjusting line breaks or paragraph boundaries in text to improve readability or to match a desired dialogue layout.

The term “grammar and notation checking” refers to a process of automatically inspecting generated text to detect and optionally correct linguistic errors, including grammatical mistakes, spelling errors, and inconsistent punctuation or symbols.

The term “postprocessed advertisement text” refers to conversation-type advertisement text that has been subjected to postprocessing so as to comply with a predetermined structure, length, and quality criteria.

The term “emotion parameter” refers to data representing an emotional state of a user, the data being usable by the processor to adjust generation or modification of advertisement text, and including at least one of a categorical label, a numeric score, or a vector representation of emotion.

The term “emotional state of a user” refers to a condition relating to a user's feelings or attitudes, such as happiness, excitement, calmness, anxiety, or dissatisfaction, as inferred or provided as data to the system.

The term “writing style” refers to characteristics of text expression, including at least tone, formality level, choice of words, and sentence structure, that can be adjusted by the processor.

The term “appeal content” refers to a portion of advertisement text that emphasizes particular product benefits, features, or messages aimed at influencing a user's interest or decision.

The term “visual expression format” refers to a content structure suitable for visual presentation, including at least a plurality of panels, characters, and utterances, as typically used in comic-style layouts or storyboard-style layouts.

The term “comic-type creative advertisement text” refers to advertisement text generated so as to correspond to a visual expression format having multiple panels, characters, and dialogues, and suitable for use in a comic-style advertisement.

The term “dialogue structure” refers to an arrangement of utterances in a conversation, including at least an order of speakers, a number of dialogue turns, and logical relationships between questions and responses.

The term “amount of information” refers to a quantity or density of factual or descriptive content included in advertisement text, such as a number of product features, level of detail, or length of explanations.

The term “re-input prompt sentence” refers to a prompt sentence provided after a first generation process, including at least updated product information, modified instructions, or additional conditions specified by the user.

The term “additional condition” refers to constraint data provided by the user in addition to basic product information, including at least one of a desired tone, length, target audience, emotional emphasis, or output format.

The term “different conversation-type advertisement text” refers to conversation-type advertisement text that is generated for the same product information but differs in at least one of tone, dialogue structure, length, or appeal content.

The term “same product information” refers to product information that identifies an identical item or service, even if the wording of a prompt sentence varies, such that the underlying attributes of the item or service remain unchanged.

In one embodiment, the invention is implemented as a networked system including a server, one or more terminals, and a communication network. The server includes at least one processor, a main memory, a non-volatile storage device, and a network interface. The terminal includes a processor, a display unit, an input unit, a memory, and a communication module.

The server executes an operating system such as a general-purpose server operating system and executes an application program implementing the functions described in the claims. The server uses, as software components, a web server module (for example, an HTTP server), an application framework (for example, a web application framework), a natural language processing library (for example, a library providing tokenization and morphological analysis), and a deep learning framework (for example, a framework providing tensor operations and automatic differentiation). The server further uses a generative AI model implemented as a neural network, stored as weight parameters and configuration data in the non-volatile storage device and loaded into main memory for inference.

The terminal executes a client application such as a browser-based application or a native mobile application. The terminal presents to the user an input interface for entering a prompt sentence including product information. For example, the user inputs a prompt sentence such as:

“Product name: XYZ, Product information: a high-performance vacuum cleaner with powerful suction and low noise.”

The terminal transmits this textual prompt sentence, as character data encoded in a character encoding scheme, to the server using a communication protocol such as HTTPS through the communication module. The terminal also receives from the server an advertisement text and controls the display unit to render the advertisement as a conversation-type dialogue.

The server stores, in memory, data structures for managing prompt sentences, extracted product information, preprocessed data, model-level prompt sentences, generated advertisement text, postprocessed advertisement text, and emotion parameters. For example, the server represents the prompt sentence as a sequence of Unicode code points, represents tokens as an array of token identifiers, and represents preprocessed data as a sequence of integer token indices associated with features such as part-of-speech tags and lemma indices.

The server uses a natural language processing library to perform morphological analysis and tokenization. The server applies a tokenizer that segments the prompt sentence into tokens according to language-specific rules, and produces a token list. The server maintains a stop-word list in memory and removes tokens mapped to stop words, thereby reducing noise before input to the generative AI model. The server applies a lemmatizer or stemmer to convert inflected word forms to base forms, thereby reducing sparsity in the token space. These operations reduce the size and variability of the input vector, which results in fewer computations in subsequent neural network layers and improved convergence of the generative AI model during training.

The server uses a model-specific tokenizer associated with the generative AI model to convert the normalized text into model token IDs. The server stores a vocabulary table mapping subword units to integer IDs. By converting the text into a compact integer sequence, the server reduces the amount of memory required for input representation and improves cache locality when loading embedding vectors during inference. This leads to reduced latency and improved throughput when handling multiple generation requests in parallel.

The server constructs a model-level prompt sentence by combining the preprocessed product information with an instruction text. The server stores template strings defining generation policies, such as:

“You are an expert advertising copywriter. Using the following product information, generate a conversation-style advertisement between a Customer and a Salesperson. Use a friendly tone and clearly highlight the product's strengths. Product information: [product information]. Output at least 6 turns of dialogue in English.”

The server inserts the preprocessed product information, such as “Product name: XYZ, Product information: high-performance vacuum cleaner with powerful suction and low noise.” into the placeholder [product information]. By constructing the model-level prompt sentence on the server side instead of passing the user's original text directly, the server can normalize the structure of prompts, reduce ambiguity in model instructions, and enforce consistent generation behavior. This reduces the number of failed or irrelevant generations and lowers the number of model calls required to obtain an acceptable output, improving computational efficiency and resource utilization.

The server uses a generative AI model implemented as a multi-layer transformer neural network having an input embedding layer, a plurality of self-attention and feedforward layers, and an output projection layer. The server stores, for each layer, parameter matrices such as query, key, value, and output projection matrices for attention, as well as weight matrices and bias vectors for feedforward networks. The server executes inference by performing matrix multiplications, non-linear activation functions, and normalization operations in a sequence defined by the transformer architecture.

The server uses a training procedure, executed offline before deployment, in which the generative AI model is trained on a large corpus of dialogue and advertisement text. The server defines a loss function such as a cross-entropy loss over the predicted next-token distribution and the ground truth token. The server updates the weight parameters using an optimization algorithm such as stochastic gradient descent with momentum or an adaptive gradient method. The server may apply data augmentation techniques such as paraphrasing and synonym replacement for product descriptions to increase robustness of the model to variations in prompt sentences. Because the model is trained on conversation-type structures with explicit speaker labels, the server can later generate conversation-type advertisement text with stable turn-taking patterns. As a result, the server reduces the time needed for postprocessing and reformatting at runtime.

The server, during inference, encodes the model-level prompt sentence into token IDs, retrieves embedding vectors from an embedding matrix, and propagates the resulting tensors through the transformer layers. The server controls generation behavior by setting parameters such as maximum output length, sampling temperature, and probability thresholds. By adjusting these parameters programmatically in response to emotion parameters and user instructions, the server can bias the generative process toward more diverse or more deterministic outputs without human intervention. This improves the reproducibility and controllability of the generation process compared to ad-hoc manual editing.

The server performs postprocessing on the raw output text generated by the generative AI model. The server parses line breaks and speaker markers, and if necessary, inserts missing speaker labels according to rule-based patterns stored in configuration data. For example, if the raw output omits a speaker label before a line that follows another speaker, the server infers the speaker based on the previous turn and inserts a label such as “Customer:” or “Salesperson:”. By using deterministic rules for speaker labeling, the server ensures that the final dialogue structure is consistent and well-formed, which reduces errors in rendering on terminals and avoids the need for manual correction by the user.

The server also applies grammar and notation checking using a language checking component. The server uses rule-based heuristics and optionally a smaller corrective language model to identify and correct obvious grammatical errors and inconsistent punctuation. The server enforces length constraints by counting tokens or characters and truncating or regenerating parts of the advertisement if they exceed predetermined thresholds. These processing steps are applied systematically by the processor and are not merely cosmetic adjustments; they directly reduce network bandwidth usage by preventing overlong responses, reduce display processing requirements on terminals, and enable predictable memory allocation in the server.

The server uses an emotion parameter representing an emotional state of the user. The server may obtain this emotion parameter from explicit user selection on the terminal, from analysis of additional user input text, or from an external emotion estimation module. The server maps the emotion parameter to a set of generation control parameters, such as tone level, politeness level, humor level, or emphasis level, stored in a configuration table. By applying this mapping within the server, the server adjusts both the model-level prompt sentence and the postprocessed advertisement text.

For example, if the emotion parameter indicates that the user is stressed and has limited time, the server modifies the model-level prompt sentence to include instructions such as “Use a concise and reassuring tone and focus on quick benefits.” The server also truncates overly long explanations in the generated text during postprocessing. This integrated adjustment in the server reduces the number of iterations needed to reach a suitable advertisement, thereby reducing processor usage and communication rounds between the server and terminals.

The server supports iterative regeneration based on re-input prompt sentences or additional conditions. The server stores the extracted product information in an internal cache associated with a session identifier. When the server receives a re-input prompt sentence such as:

“Product name: XYZ, Product information: high-performance vacuum cleaner with powerful suction and low noise. Please make the conversation shorter and more humorous.” the server reuses the stored product information and only updates control fields such as tone and length. The server then constructs a modified model-level prompt sentence and executes inference again. Because the server avoids repeated full extraction and preprocessing of product information for the same product, the server reduces redundant computations and accelerates response time. This reuse of structured data in a session-specific cache is a technical optimization that improves memory access patterns and CPU utilization.

The terminal displays the generated advertisement text in a chat-style layout. The terminal parses speaker labels and presents them as distinct visual elements, such as left-aligned and right-aligned speech bubbles. The terminal applies local rendering optimizations, such as lazy loading of long conversations and text wrapping according to screen size, thereby reducing power consumption and improving user experience on resource-constrained mobile devices.

In another embodiment, the server adjusts the generation process to output advertisement text in a visual expression format suitable for a comic or storyboard. The server modifies the instruction text in the model-level prompt sentence to specify panels, characters, and short utterances. For example, the server may insert instructions such as “Generate a four-panel comic-style advertisement, with each panel having one or two short utterances, describing how the product solves a problem.” The server then receives from the generative AI model text annotated with panel numbers and dialogues. The server postprocesses this text into a structured representation that can be mapped to visual panels on the terminal. This structured representation may include a list of panels, each with associated character roles and utterances. By providing the server-side structure, the system reduces the processing load on the terminal and enables consistent rendering across different display sizes and platforms.

In a further embodiment, the server supports multiple generative AI models with different sizes or specializations. The server selects a model according to constraints such as available computation resources, required response time, or complexity of the prompt sentence. For a simple prompt, the server may select a smaller model to reduce inference time and energy consumption. For a complex prompt or a high-importance request, the server may select a larger model with more parameters to improve quality. The server maintains routing logic that decides which model to invoke based on measured latency and past success rates. This dynamic model selection is executed automatically by the processor, and improves overall system throughput and robustness.

The server, by implementing the described data structures, neural network architecture, training procedures, preprocessing and postprocessing pipelines, caching mechanisms, emotion-based control logic, and multi-model routing, provides technical improvements over conventional systems. The server reduces the number of tokens processed per request, shortens inference time through structured prompts, reduces network communication by avoiding overlong or invalid outputs, and improves memory utilization through reuse of preprocessed product information. These effects improve the operation of the computer system itself, rather than merely automating a human advertising workflow.

The user interacts with the system only through the terminal; the user does not need to understand internal details of the generative AI model or processing pipeline. The user provides natural language prompt sentences, such as:

“Product name: FreshBrew Pro, Product information: compact coffee maker, café-quality coffee in 2 minutes. Generate a friendly conversation between a barista and an office worker.”

and

“Product name: AquaGuard 360, Product information: smart water purifier with real-time app monitoring and filter-change alerts. Generate a conversation targeting parents who care about children's health.”

The server handles all subsequent processing steps, including normalization, model-level prompt construction, generative inference, structured postprocessing, and emotion-based adaptation. By centralizing these operations on the server and implementing them with specific data structures and algorithms, the invention enables other practitioners to implement the claimed system and to obtain the technical advantages described above.

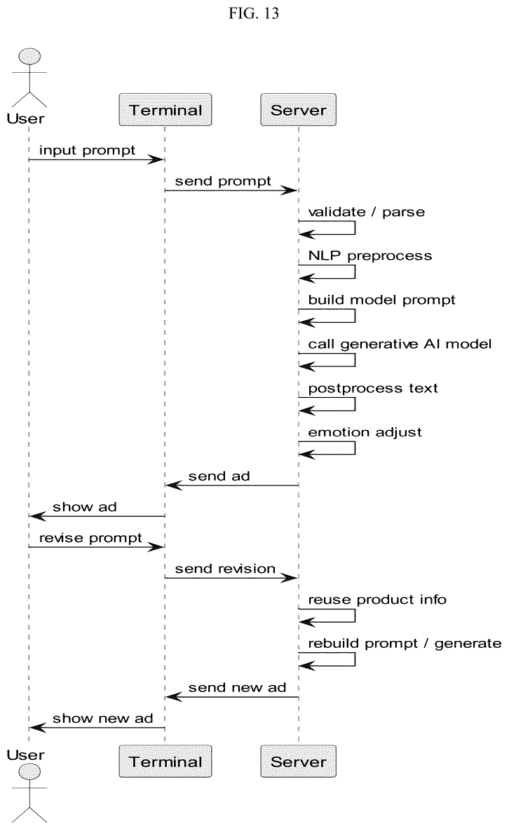

The following describes the processing flow using FIG. 13.

### Step 1

The user operates the terminal to input a prompt sentence.

The user views an input screen on the terminal and types a prompt sentence including product information, such as “Product name: XYZ, Product information: a high-performance vacuum cleaner with powerful suction and low noise.” The user then activates a control, such as a “Generate Ad” button.

Input: The terminal receives raw text input from the user via a keyboard, touch screen, or voice-to-text function.

Output: The terminal stores the prompt sentence as a character string in its memory and prepares it for transmission to the server.

### Step 2

The terminal transmits the prompt sentence to the server.

The terminal converts the stored prompt sentence into a data payload, encodes it using a character encoding scheme, and sends it over a communication network to the server using a request protocol. The terminal attaches metadata such as a session identifier and language code.

Input: The terminal uses the internal character string of the prompt sentence and associated metadata.

Output: The terminal outputs a network request that contains the prompt sentence and metadata, and sends this request to the server's network interface.

### Step 3

The server receives and validates the prompt sentence.

The server accepts the network request through a network interface and passes the payload to an application module. The server decodes the character data, extracts the prompt sentence, and checks that the sentence exists and that its length falls within predefined limits. If the validation fails, the server generates an error response. If the validation succeeds, the server proceeds with further processing.

Input: The server receives encoded character data containing the prompt sentence and metadata.

Output: The server outputs a validated prompt text string and associated request context for downstream processing, or an error message if validation fails.

### Step 4

The server extracts product information from the prompt sentence.

The server applies a text parsing routine to the validated prompt text, identifying segments corresponding to product name and product description based on delimiters such as “Product name:” and “Product information:”. The server trims whitespace and normalizes the extracted segments.

Input: The server uses the validated prompt text string as input.

Output: The server outputs structured product information, for example key-value pairs representing a product name and a product description.

### Step 5

The server performs natural language preprocessing on the product description.

The server uses a natural language processing library to perform morphological analysis and tokenization of the product description. The server removes unnecessary words using a stored stop-word list, and applies lemmatization or stemming to convert inflected forms into base forms. The server normalizes casing and removes extraneous punctuation according to predefined rules.

Input: The server receives the product description text from the structured product information.

Output: The server outputs a normalized, cleaned text representation and a sequence of linguistic tokens representing the core content of the product description.

### Step 6

The server converts the preprocessed text into model input tokens.

The server invokes a model-specific tokenizer associated with the generative AI model to map subword units of the cleaned text to integer token identifiers. The server consults a vocabulary table stored in memory to perform this mapping and constructs an ordered sequence of token IDs. The server may pad or truncate the sequence to meet length constraints of the model.

Input: The server uses the cleaned text and token list obtained from natural language preprocessing.

Output: The server outputs a preprocessed data structure containing a sequence of token IDs and, optionally, segment and position indices suitable for input to the generative AI model.

### Step 7

The server constructs a model-level prompt sentence.

The server loads an instruction template defining a creation policy for a conversation-type advertisement and roles of dialogue participants, such as “Customer” and “Salesperson.” The server inserts the normalized product information into designated placeholders in the template and concatenates the instruction text and product information into a single model-level prompt sentence.

Input: The server receives the structured product information and an instruction template string from configuration storage.

Output: The server outputs a completed model-level prompt sentence that encodes both instruction text and product information for use by the generative AI model.

### Step 8

The server encodes the model-level prompt sentence for the generative AI model.

The server applies the same model-specific tokenizer to the model-level prompt sentence and converts it into a sequence of token IDs. The server then organizes these token IDs into tensors required by the neural network, including embedding indices and positional indices.

Input: The server uses the model-level prompt sentence text string.

Output: The server outputs model input tensors representing the encoded model-level prompt sentence.

### Step 9

The server generates conversation-type advertisement text using the generative AI model.

The server provides the input tensors to a transformer-based generative AI model and configures generation parameters such as maximum output length and sampling temperature. The server executes forward propagation through multiple attention and feedforward layers, computing attention scores, hidden state vectors, and probability distributions over possible next tokens at each step. The server samples or selects token IDs based on these distributions to form an output sequence.

Input: The server receives the encoded model-level prompt tensors and generation parameters.

Output: The server outputs a raw sequence of generated token IDs corresponding to conversation-type advertisement text.

### Step 10

The server decodes the generated token IDs into text.

The server uses the inverse mapping of the model-specific tokenizer to convert the sequence of generated token IDs into a character string. The server reconstructs words and punctuation from the subword units and resolves tokenization artifacts such as extra spaces.

Input: The server uses the generated token ID sequence.

Output: The server outputs a raw advertisement text string representing a conversation between dialogue participants.

### Step 11

The server postprocesses the conversation-type advertisement text.

The server analyzes the raw text string for speaker labels and line breaks. The server inserts or corrects speaker labels such as “Customer:” and “Salesperson:” according to rule-based patterns and ensures that each utterance is on a separate line. The server applies grammar and notation checking to identify simple errors and replaces incorrect segments based on correction rules. The server adjusts the number of dialogue turns or characters by truncating or regenerating sections if the text exceeds configured thresholds.

Input: The server receives the raw advertisement text string generated by the generative AI model.

Output: The server outputs a postprocessed advertisement text string formatted as a structured conversation with consistent speaker labels and length.

### Step 12

The server adjusts the advertisement text according to an emotion parameter.

The server obtains an emotion parameter representing the emotional state of the user and maps this parameter to style control values, such as tone strength, humor level, or conciseness. The server modifies either the model-level prompt sentence used for regeneration or the postprocessed advertisement text by inserting or replacing phrases, changing sentence length, or altering emphasis terms according to predefined style rules.

Input: The server uses the emotion parameter and either the model-level prompt sentence or the postprocessed advertisement text.

Output: The server outputs emotion-adapted advertisement text that reflects the emotional state of the user.

### Step 13

The server transmits the final advertisement text to the terminal.

The server packages the emotion-adapted, postprocessed advertisement text together with metadata such as a session identifier and model information and sends it to the terminal through the network interface. The server encodes the text using a character encoding and constructs a response message.

Input: The server receives the final advertisement text string and related metadata from internal modules.

Output: The server outputs a response message containing the final advertisement text and transmits it to the terminal.

### Step 14

The terminal displays the conversation-type advertisement to the user.

The terminal receives the response message from the server and decodes the character data. The terminal parses the speaker labels and constructs a conversational display, such as alternating message bubbles or labeled text blocks. The terminal renders the advertisement on the display unit and may apply styling such as color differentiation and indentation.

Input: The terminal uses the final advertisement text provided by the server.

Output: The terminal outputs a visual presentation of the conversation-type advertisement to the user on the display screen.

### Step 15

The user reviews and optionally modifies the prompt sentence or conditions.

The user reads the displayed conversation-type advertisement on the terminal and decides whether to accept or adjust it. If the user requests a different style or length, the user inputs a modified prompt sentence or additional conditions, such as “Please make the conversation shorter and more humorous.”

Input: The user uses the visual presentation of the conversation-type advertisement and the input interface on the terminal.

Output: The user produces a revised prompt sentence or additional conditions, which the terminal captures as new input for subsequent processing.

### Step 16

The terminal and the server cooperate to regenerate different conversation-type advertisement text for the same product information.

The terminal sends the revised prompt sentence or additional conditions to the server. The server uses previously stored product information associated with the session and updates only the control parameters such as tone, length, or emphasis based on the new input. The server reconstructs the model-level prompt sentence, repeats encoding, inference, and postprocessing, and generates a different conversation-type advertisement text for the same product information.

Input: The terminal supplies the revised prompt sentence or additional conditions, and the server uses the stored product information and previous session state.

Output: The server outputs a new advertisement text variant, and the terminal displays this variant to the user, enabling iterative refinement without redundant extraction of product information.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented advertising systems typically treat product information, user instructions, and user state (such as mood or engagement) as separate and weakly coupled data streams. A conventional content server generally receives static product data, applies a fixed template, and outputs a single version of an advertisement, regardless of the user's current emotional state, the user device's presentation capabilities, or historical feedback regarding how well previous prompts to a generative model have performed. As a result, several technical problems arise in the operation of such computer systems.

First, the processor in a conventional system does not dynamically structure incoming product information into machine-usable attribute data tailored for prompt generation, and does not systematically incorporate emotion-recognition outputs into the control flow for a generative AI model. The generative AI model is therefore invoked with coarse or generic prompts, which often leads to suboptimal use of computing resources: the model generates lengthy or irrelevant advertisement text, requiring additional manual filtering or regeneration. This increases processor load, network traffic, and latency in providing an advertisement to a user terminal.

Second, a conventional system typically uses a single static prompt pattern per product, which prevents the system from efficiently exploring different prompt formulations and output formats. Because the processor is not configured to generate multiple distinct prompt sentences for the same structured product attributes and to adapt these prompts based on user emotion and device capabilities, the system cannot systematically optimize content quality or system performance. This limits the system's ability to reduce iterations, minimize bandwidth usage for inappropriate media formats, and shorten the end-to-end response time.

Third, existing systems usually do not implement a closed feedback loop at the level of prompt-generation logic. Although some systems may log generated content, they often do not log, in a structured way, the relationship among (i) the exact prompt sentences sent to the generative AI model, (ii) the model responses, (iii) the detected emotional state of the user, and (iv) subsequent user actions such as approval or correction. Without this linkage, the processor cannot algorithmically refine prompt-generation rules and parameter settings of the generative AI invocation. Consequently, the computer system cannot automatically improve its own behavior over time; it remains dependent on manual tuning, which is slow, error-prone, and resource-inefficient.

Fourth, conventional architectures do not tightly integrate an emotion-recognition pipeline with media-format selection and layout generation. Even when emotional state is estimated, that information is often used only at a superficial business-logic level and is not fed back into low-level decisions such as text length, wording strength, or the selection among text, still-image, and moving-image formats. The lack of such integration causes mismatches between user context and media format, leading to unnecessary video generation and transmission in low-bandwidth conditions, or to underutilization of richer formats when the device could handle them, thereby failing to leverage the capabilities of the terminal and network environment in an optimal way.

Therefore, there is a need for a computer-implemented system and method that (i) automatically converts raw product information and user instructions into structured attribute data, (ii) fuses this data with emotion-recognition outputs to generate optimized prompt sentences for a generative AI model, (iii) dynamically selects and adjusts media formats and layouts based on device capabilities and emotional state, and (iv) records and exploits detailed interaction histories to update prompt rules and model parameters. Such a system should improve the efficiency, responsiveness, and adaptability of the underlying computing environment itself, rather than merely automating a manual creative process.

The specific processing by the specific processing unit 290 of the data processing device 12 in Application Example 2 is realized by the following means.

The present invention provides a server comprising a processor configured to acquire, from a user terminal, information related to a product and a natural language instruction sentence, convert the information related to the product into structured attribute information using a natural language processing technique, analyze facial information and voice information acquired from the user terminal using an emotion recognition technique to specify an emotional state of a user, generate, based on the structured attribute information and the emotional state, at least one prompt sentence for instructing a generative AI model to generate conversation-type or story-type advertisement content, transmit the at least one prompt sentence to the generative AI model and obtain advertisement content from the generative AI model, adjust wording, expression, length, and medium format of the obtained advertisement content in accordance with the emotional state and a display capability of the user terminal so as to generate optimized advertisement content including at least one of a text format, a still-image format, and a moving-image format, output the optimized advertisement content to the user terminal and convert the optimized advertisement content into a data format suitable for sharing via an external information providing service, and record, in association, each prompt sentence, each response from the generative AI model, the emotional state, and an operation history regarding approval or correction by the user, and update generation rules for the prompt sentence and parameter settings for the generative AI model on the basis of the recorded information. This enables the computer system to automatically tailor prompt sentences and advertisement outputs to user emotion and device capabilities, to reduce unnecessary iterations and resource usage in invoking the generative AI model, to dynamically select and adapt media formats and layouts for efficient transmission and rendering, and to iteratively refine its own prompt-generation and model-control logic over time, thereby improving overall processing efficiency, responsiveness, and adaptability of the advertising content generation infrastructure.

The term “system” refers to an integrated set of hardware resources, software resources, and communication interfaces that cooperatively execute processing for acquiring input data, generating advertisement content, and outputting the advertisement content to one or more terminals or external services.

The term “processor” refers to one or more hardware-based processing units, such as central processing units or graphics processing units, and any associated control circuitry configured to execute instructions of computer programs to perform the described acquisition, analysis, generation, adjustment, and output operations.

The term “user terminal” refers to an information processing apparatus, such as a smartphone, tablet, personal computer, or similar computing device, that includes at least one display unit and one or more input units and is capable of transmitting data to and receiving data from the server via a communication network.

The term “information related to a product” refers to descriptive data concerning an item or service to be advertised, including at least one of a designation, attribute, feature, function, specification, price, intended use, or target user segment, provided in natural language form or in structured form.

The term “natural language instruction sentence” refers to a text string expressed in a human language and input by a user to specify at least one of a desired advertisement style, content, tone, format, length, scenario, or target audience, and serving as part of a prompt to a generative AI model.

The term “natural language processing technique” refers to a computational method or algorithm for analyzing and transforming text data, including at least one of tokenization, morphological analysis, part-of-speech tagging, syntactic parsing, semantic analysis, key phrase extraction, or normalization.

The term “structured attribute information” refers to data obtained by converting unstructured text related to a product into a machine-readable representation, such as a set of attributes, labels, feature-value pairs, or schema-based records usable for subsequent prompt construction and content generation.

The term “facial information” refers to image data or image-derived feature data representing at least a portion of a user's face, including spatial or temporal information sufficient to infer facial expressions and changes over time.

The term “voice information” refers to audio data or audio-derived feature data representing the user's speech or vocal sounds, including at least one of pitch, intensity, prosody, or spectral features that can be used to infer an emotional state.

The term “emotion recognition technique” refers to a computational method or algorithm that processes at least one of facial information and voice information to estimate, classify, or quantify a user's emotional state, such as joy, sadness, excitement, calmness, or similar affective conditions.

The term “emotional state” refers to a representation of the user's affective condition at a given time, expressed as at least one of a categorical label, a set of labels, or a numerical vector indicating intensity or probability for one or more emotion types.

The term “generative AI model” refers to a machine-learned model that receives input data including a prompt sentence and stochastically or deterministically produces new content data, such as natural language text, images, or multimedia sequences, that was not explicitly stored in a database but is generated based on learned patterns.

The term “prompt sentence” refers to a text-based instruction input to a generative AI model, specifying at least one of a task, constraints, style, tone, structure, or content elements for the content to be generated by the model.

The term “conversation-type advertisement content” refers to advertisement content having a dialog form, including at least two utterances associated with different speakers or roles, such as characters or narrator and user, arranged to promote a product or service.

The term “story-type advertisement content” refers to advertisement content that includes a sequence of events, scenes, or actions involving one or more characters and a setting, and that presents a narrative for promoting a product or service.

The term “wording, expression, length, and medium format” refers respectively to a selection of lexical items and phrasing, stylistic and tonal characteristics, an amount of content measured by tokens or time, and a content representation type such as text-only, still-image-enriched, or moving-image-enriched.

The term “optimized advertisement content” refers to advertisement content that has been adjusted in at least one of wording, expression, length, structure, or medium format so as to better match at least one of a user's emotional state, a device capability, a network condition, or a target distribution channel.

The term “text format” refers to a representation of content as a sequence of characters or tokens suitable for display as written language on a screen or for conversion into speech by a speech synthesis component.

The term “still-image format” refers to a representation of content as a non-moving visual frame or a sequence of such frames intended to be displayed individually, and may include one or more images accompanied by textual annotations.

The term “moving-image format” refers to a representation of content as a temporal sequence of visual frames, optionally synchronized with audio, suitable for playback as a video or animation.

The term “display capability of the user terminal” refers to the hardware and software characteristics of the user terminal related to visual and audio presentation, including at least one of screen size, resolution, color depth, frame rate, supported media formats, processing power, and available memory.

The term “external information providing service” refers to an external platform or system accessible via a communication network and capable of receiving and distributing content, including at least one of a social networking service, a video sharing service, a messaging service, or a web publishing service.

The term “data format suitable for sharing” refers to a representation of advertisement content conforming to specification constraints of an external information providing service, including at least one of file type, resolution, aspect ratio, maximum size, character limit, or metadata requirements.

The term “operation history regarding approval or correction” refers to log data indicating user interactions with generated advertisement content, including at least one of explicit approval, rejection, editing operations, regeneration requests, sharing actions, and timestamps associated with such operations.

The term “generation rules for the prompt sentence” refers to a set of conditions, templates, parameters, or algorithms used by the processor to construct a prompt sentence, including selection and arrangement of attributes, insertion of emotion descriptors, and choice of style indicators.

The term “parameter settings for the generative AI model” refers to configurable values supplied to the generative AI model at inference time, including at least one of model identifier, sampling temperature, maximum output length, top-k or top-p values, presence penalties, or frequency penalties.

The term “layout information” refers to data describing a spatial and temporal arrangement of visual and textual elements in a presentation, including at least one of panel boundaries, character positions, speech bubble positions, layering order, timing, and transitions.

The term “comic-style advertisement content” refers to advertisement content arranged in a multi-panel layout or similar visual structure, in which characters, backgrounds, and text elements are placed to resemble a comic strip or graphic narrative that promotes a product or service.

The term “dialogue between characters” refers to a sequence of utterances in text or audio form, each utterance being associated with a distinct speaker role, and arranged in an alternating or structured manner to simulate interaction among fictional or representative entities.

The term “scene configuration” refers to information describing at least one of a location, time, participants, objects, and visual perspective for a part of story-type advertisement content.

The term “identical structured attribute information” refers to structured attribute information representing the same underlying product or service, such that the set of core attributes, apart from optional formatting differences, is treated as equivalent for advertisement generation.

The term “emotional tone of advertisement content” refers to a target affective quality prescribed for the advertisement content, such as cheerful, calm, serious, humorous, or encouraging, which influences wording, pacing, and narrative emphasis.

The term “dialogue pattern” refers to a configuration of conversational exchange, including at least one of number of speakers, turn-taking structure, narrative viewpoint, and relative length of utterances for different roles.

The term “output destination information providing service” refers to a particular external information providing service selected as a delivery target for the advertisement content, each such service having its own content presentation constraints and interaction patterns.

The term “individually optimize” refers to adjusting each instance of advertisement content separately, based on data specific to a corresponding user, emotional state, device capability, or target service, rather than applying a uniform adjustment across multiple users or outputs.

In one embodiment, a server executes a set of computer programs that implement the claimed system. The server includes at least one central processing unit, at least one graphics processing unit, a main memory, a non-volatile storage device, and a network interface. The server runs an operating system such as a general-purpose server operating system, and application software implemented, for example, in a high-level language. The server communicates with one or more terminals via a packet-based communication network.

A terminal includes a processor, a memory, a display, a camera, a microphone, a speaker, and a network interface. The terminal runs a client application or web browser that renders user interfaces, captures user input, and transmits and receives data to and from the server. A user operates the terminal to input product-related information and natural language instruction sentences, and to view and interact with generated advertisement content.

The server generates and manages multiple software modules. In one embodiment, the server includes a natural language processing module, an emotion recognition integration module, a prompt construction module, a generative AI control module, a content optimization module, a layout rendering module, a logging and feedback module, and a communication module. Each module executes as one or more processes or threads, exchanging data through predefined data structures stored in memory or a database.

The server uses specific software libraries and frameworks to implement these modules. For example, the server uses a natural language processing framework such as a tokenization and parsing library to perform tokenization, part-of-speech tagging, and key-phrase extraction; uses a machine learning framework such as a deep learning library to host and execute a generative AI model; and may use a computer vision library to integrate external emotion recognition outputs if such processing is performed on the server side. The server stores persistent data, such as structured product attributes, user emotion histories, prompt templates, and model configuration parameters, in a relational or document-oriented database.

The server receives, from the terminal, product-related information and a natural language instruction sentence. The user enters these items through an input form rendered by the terminal. For example, the user may input:

“Product name: XYZ, Product information: high-performance vacuum cleaner. Please create a short conversation-style advertisement where a busy parent happily discovers how XYZ makes cleaning much easier and more fun.”

Alternatively, the user may input:

“New eco bag. Please create a short play-style ad that introduces the features of this eco bag in an engaging and friendly tone.”

The terminal transmits the text strings representing such prompt sentences and product descriptions to the server in a structured request. The server parses the request and stores the raw text into a database record associated with a particular session or user identifier.

The server uses the natural language processing module to convert the unstructured product-related information into structured attribute information. The natural language processing module segments the text into tokens, assigns part-of-speech tags, detects noun phrases, and applies dependency parsing to identify product-related entities and their modifiers. The server maps these entities and modifiers into a schema of attribute fields such as “category,” “core function,” “feature,” “benefit,” and “target user.” The server stores the resulting structured attribute information as a typed record. This explicit structuring reduces ambiguity, allows deterministic selection of attributes when constructing prompt sentences, and improves processing speed and consistency, because downstream modules access attribute values via direct indexing rather than ad hoc text search.

The terminal captures facial information and voice information from the user through the camera and microphone. The terminal executes local code or invokes an external emotion recognition service to analyze these signals. In one embodiment, the terminal uses an emotion recognition software development kit that provides functions for facial landmark detection, expression classification, and prosodic feature extraction. The terminal calculates or receives from the SDK an emotional state vector, which may contain scores for categories such as joy, sadness, anger, surprise, and calmness. The terminal transmits this emotional state vector to the server along with a timestamp and a session identifier.

The server integrates the emotional state vector with the structured attribute information. The server stores the emotional state as a record linked to the current session. The emotion recognition integration module normalizes the scores and selects a dominant emotion or a combination of emotions. For example, the server may determine that the user is predominantly “joyful” with a high intensity score, or “sad” with moderate intensity. The server then represents the emotional state as a set of labels and numeric values that can be used in prompt construction.

The server uses the prompt construction module to generate a prompt sentence for the generative AI model. The module applies explicit templates that refer to particular attribute fields and emotional state labels. For example, the server may generate, from structured attributes and a joyful emotional state, the following prompt sentence:

“Product name: XYZ. Product information: high-performance vacuum cleaner with strong suction and low noise, designed for busy households. The user is currently feeling joyful. Please create a short conversation-style advertisement (a small play) where a busy parent happily discovers how the XYZ vacuum cleaner makes cleaning much easier and more fun, using an upbeat and energetic tone.”

In another example, if the emotional state is classified as sadness, the server may generate:

“The user is feeling sad and has searched for relaxing bath items. Please write a short play-style advertisement that gently encourages the user and introduces a new bath bomb set, in a calm and supportive tone, highlighting how the product can help the user relax.”

The prompt construction module selects and orders attribute values according to rules stored in configuration data. The rules specify which attributes should appear in the beginning of the prompt, which emotional descriptors to insert, and how to phrase the instruction to the generative AI model. The rules also include conditions for varying the style, such as specifying whether the advertisement should be conversation-type or story-type, depending on product category and emotion. Because the rules are stored and executed programmatically, the server can adjust them over time based on feedback without modifying model parameters, thereby improving system behavior with low computational overhead.

The server uses the generative AI control module to communicate with the generative AI model. The generative AI model is implemented as a multi-layer neural network, such as a transformer-based sequence model trained on a large corpus of text. The neural network includes an embedding layer that converts tokens to vector representations, multiple attention blocks that compute weighted combinations of these vectors, and feedforward layers that transform intermediate representations. The model is trained beforehand using a supervised or self-supervised objective, such as next-token prediction, with an optimization algorithm such as stochastic gradient descent or one of its variants. The training process minimizes a loss function, such as cross-entropy loss between predicted and actual tokens, by updating weight parameters across the network.

The generative AI control module translates the prompt sentence into token identifiers determined by a fixed vocabulary. The module then sends these token identifiers, along with configuration parameters such as maximum output length, sampling temperature, and nucleus sampling threshold, to the generative AI model. The model computes, for each new position in the output sequence, a probability distribution over the vocabulary tokens. The module samples or selects tokens from this distribution according to the specified parameters, thereby generating a sequence of tokens that forms the advertisement content. The server decodes this token sequence into a text string and treats it as the generated advertisement script.

The server's modular control over parameters such as temperature and maximum length has technical advantages. By adjusting these parameters per prompt, the server can constrain the length of generated output to match device bandwidth and display constraints, thereby reducing network load and rendering latency. By tuning temperature based on emotion and past feedback, the server can reduce the probability of generating inappropriate or irrelevant content, improving the average quality of outputs and reducing the number of regeneration requests, which further reduces computation and network usage.

The server uses the content optimization module to adapt the generated advertisement script to the emotional state and device characteristics. The module parses the generated script into utterances, analyzes sentiment at the sentence level, and detects stylistic markers such as exclamation marks or strong adjectives. The module compares these features with target ranges associated with each emotion. For example, for a “sad” emotional state, the module may limit the number of highly energetic expressions and enforce a maximum sentence length to maintain a calm tone. If the script does not satisfy these constraints, the module generates a refinement prompt sentence, such as:

“Rewrite the following advertisement in a warmer and more comforting tone, while preserving its core product information and keeping the length under 150 words: [original script].”

The server then sends this refinement prompt and the original script to the generative AI model, receives a revised script, and repeats the constraint checking. This non-standard, constraint-driven refinement loop causes the computer system to execute a particular sequence of analysis and rewriting operations that differ from a conventional, single-shot text generation. As a result, the system systematically converges toward text that satisfies technical requirements such as length and sentiment bounds, which improves predictability and consistency of system output and reduces manual adjustments.

The layout rendering module in the server determines the medium format and presentation structure. The module accesses device capability data, such as screen dimensions, supported codecs, and current network conditions, which may be reported by the terminal. Based on these parameters and the type of advertisement content (conversation-type, story-type, or comic-style), the module selects an appropriate format: text only, text with still images, or moving image.

When the server selects a still-image format, the module extracts key scenes from the script, such as moments where a character discovers a benefit of the product. The module constructs auxiliary prompt sentences for an image generation model, for example:

“Create an illustration of a smiling parent using the XYZ high-performance vacuum cleaner in a bright living room, with visible dust being removed from the carpet.”

The server sends such prompts to an image generation model running on a deep learning framework. The model may be implemented as a generative neural network, such as a diffusion-based image generator, trained with a loss function that encourages matching of visual features to text descriptions. The server receives image data from the model and associates the images with specific lines of dialogue or narrative segments. The layout rendering module then defines a data structure representing positions and sizes of panels, images, speech bubbles, and text blocks. This structured layout optimizes rendering efficiency because the terminal can render complex pages based on compact layout metadata rather than arbitrary HTML content.

In a comic-style embodiment, the server uses structured attribute information and the emotional state to construct a storyboard. The server assigns each scene a role, such as “introduction,” “conflict,” or “resolution,” and maps these roles to panels. The prompt sentence for the generative AI model specifies that the output should describe dialogue and actions per panel. For example, the server may generate:

“Using the following product information, write a four-panel comic-style advertisement. Panel 1: introduce a character who is struggling with cleaning. Panel 2: show how they discover the XYZ high-performance vacuum cleaner. Panel 3: depict them using the vacuum cleaner and being pleasantly surprised. Panel 4: show them happily enjoying a clean home and briefly summarizing the main benefits.”

The server receives the description and uses it to generate comic-style advertisement content. This structured panel approach reduces ambiguity, permits alignment of text and images, and allows the system to generate visually consistent layouts that render efficiently on various device types.

The server uses the communication module to transmit optimized advertisement content to the terminal. The module packages the script and any image or video resources into a response conforming to a specified protocol. The server may compress images or transcode video to match device and network constraints, thereby reducing bandwidth usage and minimizing buffering. The terminal receives the response, parses the layout and media references, downloads required media, and renders the advertisement on the display. Because the layout is precomputed, the terminal's processor can efficiently render the content without expensive layout calculations.

The server uses the logging and feedback module to record each prompt sentence, each response from the generative AI model, the emotional state, device characteristics, and user interactions such as approvals, rejections, and edits. The server stores these logs with unique identifiers linking prompt-response pairs and associated context. Periodically, the server analyzes these logs to compute metrics such as acceptance rate per prompt template, average length and sentiment deviation, and frequency of refinement loops. The server updates generation rules for prompt sentences and default parameter settings for the generative AI model according to these metrics. For example, if a particular template often leads to user rejection, the server demotes the use of that template. This data-driven adaptation improves the technical performance of the system, because subsequent generations are more likely to satisfy user requirements on the first attempt, reducing computation and communication overhead.

The system thus improves computer technology in several ways. By converting product information into structured attribute information before prompt construction, the server reduces computational complexity for downstream modules and improves consistency of prompts. By integrating emotion recognition vectors into prompt and layout decisions in a deterministic and rule-based manner, the server reduces the need for repeated manual interventions and aligns content generation with machine-readable states, rather than vague business rules. By implementing a constrained refinement loop that checks advertisement scripts against quantitative constraints and uses secondary prompts for correction, the server introduces an algorithmic control layer that improves predictability, reduces error rates, and shortens convergence time. By logging prompt-model-emotion-user interaction tuples and updating prompt-generation rules based on statistical analysis of these logs, the server performs a technical optimization of its own internal behavior, leading to measurable improvements in processing speed, resource utilization, and output quality.

In another embodiment, the server hosts the emotion recognition function instead of the terminal. The terminal transmits raw or compressed image and audio streams to the server, and the server uses a computer vision library and a speech analysis library to compute the emotional state vector. In this embodiment, the server can unify and standardize emotion recognition models across different terminals with diverse hardware, ensuring consistent emotional state estimation. The server may also adjust frame rates and audio sampling rates based on network conditions to maintain a balance between recognition accuracy and bandwidth consumption.

In a further embodiment, the generative AI model is not a single monolithic model but a plurality of specialized models. The server may use one model optimized for short dialogue generation and another model optimized for narrative descriptions. The generative AI control module selects which model to invoke based on structured attributes and emotion. For example, for a product suited for quick social media posts, the server uses a short-form dialogue model, while for a more complex product requiring explanation, the server uses a long-form narrative model. This selection reduces computational waste, because smaller models can be used when sufficient, and larger models are reserved for cases where they add value.

In another variation, the server precomputes generic prompts and partial advertisement structures for frequently requested product categories and emotional combinations. When the server detects that incoming requests match such patterns, it can reuse and slightly customize these structures, rather than constructing prompts from scratch, which further reduces processing time and resource usage.

The system is not limited to the example prompt sentences described above. Any natural language instruction that specifies product information and desired style, such as:

“Create a conversation-style ad for a new smartphone with a high-resolution camera and long battery life, where two friends discuss the advantages of the phone in a casual tone.”

or

“Generate a short play-style advertisement for a camping tent and lantern targeting users who enjoy outdoor activities, suitable for a video format.” may be used. The server treats these sentences as inputs to the same structured pipeline, ensuring that the technical advantages described above are retained regardless of specific phrasing.

Accordingly, the system combines a specific internal data structure design, a modular neural network execution control, and a rule-based prompt and layout pipeline tightly integrated with emotion recognition and device characteristics. This combination causes the computer system to operate in a way that goes beyond mere automation of human creative tasks, and instead effects a concrete improvement to the functioning of the computer itself in terms of processing efficiency, content generation accuracy, data management, and communication resource usage.

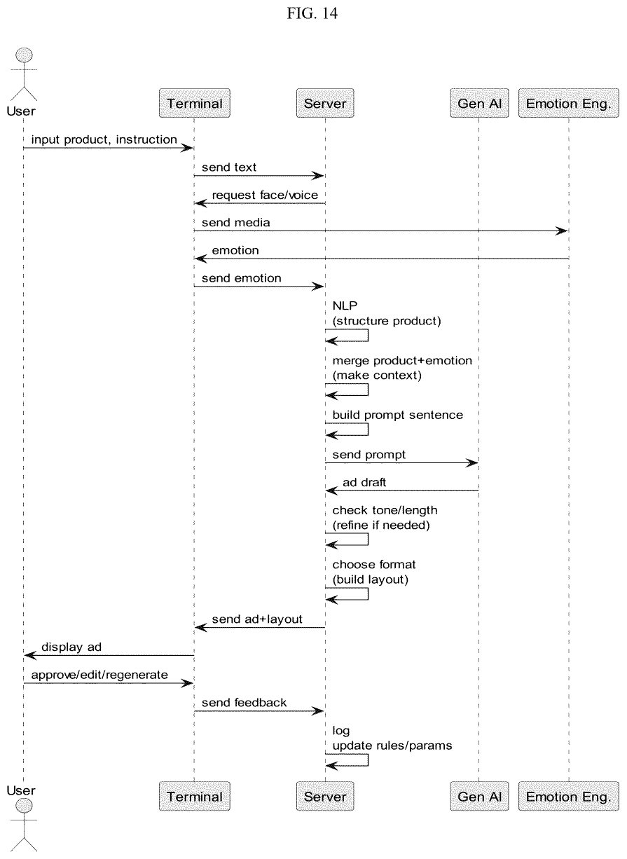

The following describes the processing flow using FIG. 14.

### Step 1

The user operates the terminal to open an application screen or web page provided by the server.

Input: No prior data; the user sees blank input fields on the terminal.

Output: User-entered text data representing product-related information and an initial instruction.

The terminal displays input fields for a product name, product information, and a free-form natural language instruction sentence. The user types text such as “Product name: XYZ, Product information: high-performance vacuum cleaner with strong suction and low noise. Please create a short conversation-style advertisement where a busy parent happily discovers how XYZ makes cleaning much easier and more fun.” The terminal stores these character strings in memory as a request object.

### Step 2

The terminal transmits the user's input to the server.

Input: Text strings representing the product name, product information, and instruction sentence.

Output: A structured request message delivered to the server over a network connection.

The terminal packages the text strings into a structured message including identifiers such as a user ID or session ID and sends the message to the server via a secure protocol. The terminal establishes a network connection and writes the request message to the socket for delivery to the server.

### Step 3

The server receives and validates the product-related information and instruction sentence.

Input: The structured request message from the terminal.

Output: Validated raw text fields stored in a server-side data record.

The server parses the request, extracts product name, product description, and instruction sentence fields, and checks that required fields are present and in correct format. The server normalizes character encoding and trims unnecessary whitespace. The server then writes the validated text into a database record indexed by a session identifier.

### Step 4

The terminal acquires facial information and voice information from the user.

Input: The user's real-time face and voice as physical signals.

Output: Digitized image frames and audio samples representing the user's expressions and speech.

The terminal activates the camera and microphone with user permission, samples video frames at a predetermined frame rate, and samples audio at a specified sampling rate. The terminal buffers the frames and audio segments and converts them into digital data arrays suitable for further processing.

### Step 5

The terminal or the server derives an emotional state from the facial information and voice information.

Input: Image frames and audio samples captured by the terminal.

Output: An emotional state vector or label set describing the user's current emotional condition.

The terminal or the server applies an emotion recognition algorithm that detects facial landmarks, measures geometric relationships between facial features, and extracts prosodic features from the audio such as pitch and intensity. The algorithm maps these features into an emotion space, producing values such as “joy: 0.8, sadness: 0.1, calmness: 0.6.” The terminal or the server converts these values into a compact emotional state representation and associates it with the current session.

### Step 6

The server transforms unstructured product-related information into structured attribute information.

Input: Raw text fields containing product name and product description.

Output: A structured attribute record with fields such as category, feature, benefit, and target user.

The server invokes a natural language processing module to tokenize the product description, label part-of-speech tags, and detect noun phrases. The server identifies core product attributes (for example “vacuum cleaner,” “strong suction,” “low noise,” “busy households”) and maps them into a predefined schema. The server then stores this structured attribute record in a database linked to the session.

### Step 7

The server integrates the structured attribute information with the emotional state.

Input: The structured attribute record and the emotional state vector for the session.

Output: A combined context object containing product attributes and emotion descriptors.

The server reads the attribute record and the emotional state from storage and constructs a composite object, for example a data structure with keys for product category, features, benefits, dominant emotion, and emotion intensity. The server selects the dominant emotion based on the highest score and also retains secondary emotions if needed. This composite object becomes the basis for constructing a prompt sentence.

### Step 8

The server generates at least one prompt sentence for the generative AI model.

Input: The combined context object including structured attributes and emotional state.

Output: One or more prompt sentences formulated as natural language strings.

The server applies prompt generation rules stored in configuration data. The server inserts attribute values and emotion labels into template strings, orders them according to rule priorities, and determines the desired advertisement style. For example, the server generates a prompt sentence such as “Product name: XYZ. Product information: high-performance vacuum cleaner with strong suction and low noise, designed for busy households. The user is currently feeling joyful. Please create a short conversation-style advertisement (a small play) where a busy parent happily discovers how the XYZ vacuum cleaner makes cleaning much easier and more fun, using an upbeat and energetic tone.” The server may also generate alternative prompt sentences varying tone or structure to enable multiple advertisement variants.

### Step 9

The server transmits the prompt sentence to the generative AI model and invokes content generation.

Input: One or more prompt sentences and associated generation parameters such as maximum length and sampling temperature.

Output: One or more raw advertisement scripts generated by the generative AI model.

The server encodes the prompt sentence into token identifiers and sends these tokens along with parameter values to the generative AI model through an API call or internal function call. The generative AI model computes probability distributions over tokens and produces sequences of tokens representing advertisement scripts. The server decodes the token sequences into text strings and collects them as candidate advertisement content.

### Step 10

The server evaluates and adjusts the generated advertisement content based on constraints.

Input: Generated advertisement scripts and the emotional state and device capability information.

Output: An optimized advertisement script that satisfies length, tone, and style constraints.

The server performs sentiment analysis and feature extraction on the generated scripts, measuring properties such as total token count, average sentence length, sentiment polarity, and frequency of strong expressions. The server compares these measurements with target constraints associated with the emotional state. If a script deviates from constraints, the server builds a refinement prompt sentence such as “Rewrite the following advertisement in a warmer and more comforting tone, while preserving its core product information and keeping the length under 150 words: [script].” The server passes this refinement prompt and the script back to the generative AI model, receives a revised script, and repeats analysis until the constraints are met or a maximum number of iterations is reached.

### Step 11

The server determines the medium format and constructs layout data for presentation.

Input: The optimized advertisement script, device capability data from the terminal, and optional configuration for output channels.

Output: A layout specification indicating whether the content is text-only, text plus still images, or moving images, along with positions and associations.

The server reads the terminal's display characteristics and supported media formats and selects a medium format that matches both the content and the device. For example, the server may choose conversation bubbles and still images for a smartphone. The server extracts key dialogue turns and narrative moments to assign to panels or time segments and constructs a layout structure describing where text and images should appear on the screen.

### Step 12

The server optionally generates visual media based on the advertisement script.

Input: The optimized script and layout structure, including identified scenes where visuals are beneficial.

Output: One or more image or video assets associated with specific parts of the script.

The server formulates additional prompt sentences for an image or video generation model, specifying visual scenes such as “Create an illustration of a smiling parent using the XYZ high-performance vacuum cleaner in a bright living room.” The server sends these prompts to a visual generative model and receives bitmap images or encoded video segments. The server stores references to these media assets in the layout structure by linking scene identifiers to resource identifiers.

### Step 13

The server packages the advertisement content and transmits it to the terminal.

Input: The final optimized script, layout specification, and associated media resources or references.

Output: A response message containing the advertisement content and layout data for rendering on the terminal.

The server serializes the layout structure, embeds the script and resource URLs or media data, and constructs a response in a predefined format. The server sends this response to the terminal over the network, optionally applying compression or streaming protocols when media size is large.

Step 14

The terminal renders the advertisement content for the user.

Input: The response message containing the script, layout specification, and media resources or references.

Output: A rendered advertisement displayed on the terminal's screen and optionally played through its speaker.

The terminal parses the layout structure, downloads any referenced media resources from the server, and creates on-screen components such as text boxes, speech bubbles, and image containers according to the specified positions and sizes. The terminal draws the content in the correct order and plays any audio or video segments as instructed, thereby presenting the conversation-style or story-type advertisement to the user.

### Step 15

The user interacts with the rendered advertisement and provides feedback.

Input: The visual and auditory presentation of the advertisement content.

Output: User actions such as approvals, rejections, edits, regeneration requests, and sharing commands.

The user reads or watches the advertisement and selects available controls on the terminal interface, such as “Approve,” “Edit text,” “Generate another version,” or “Share to social network.” The terminal captures these actions and encodes them as operation commands to be sent back to the server.

### Step 16

The terminal transmits user interaction data to the server.

Input: Operation commands representing the user's feedback and any edited text content.

Output: A feedback message delivered to the server describing user decisions and modifications.

The terminal constructs a message containing the type of action, the current advertisement identifier, and, if applicable, edited text segments. The terminal sends this message to the server via the same communication channel used for earlier requests.

### Step 17

The server logs the interaction and updates prompt-generation and model-control rules.

Input: The feedback message, the original prompt sentences, the generative AI responses, the emotional state, and device capability data associated with the session.

Output: Updated statistical records and, optionally, modified configuration parameters for future runs.

The server stores the feedback along with links to the original prompts and generated scripts in a log database. The server computes statistics such as acceptance rates per prompt template and average number of refinement iterations. Based on these statistics, the server adjusts template selection priorities, updates default temperature and length parameters for certain product-emotion combinations, and refines rule thresholds for sentiment and length. These updated rules and parameters are written back to configuration storage and will be applied in subsequent executions, thereby improving generation efficiency and output quality over time.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

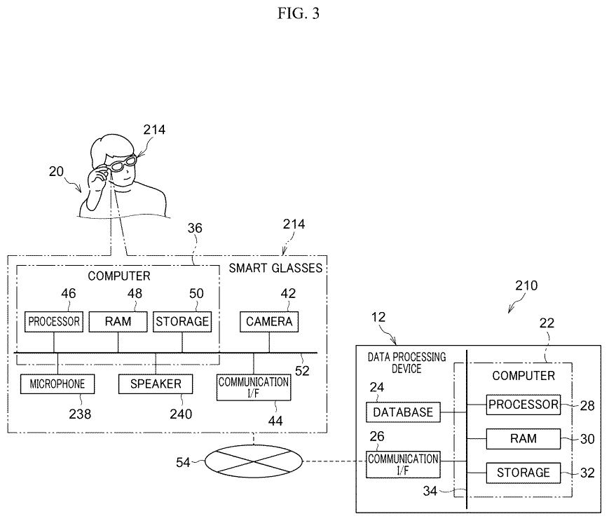

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

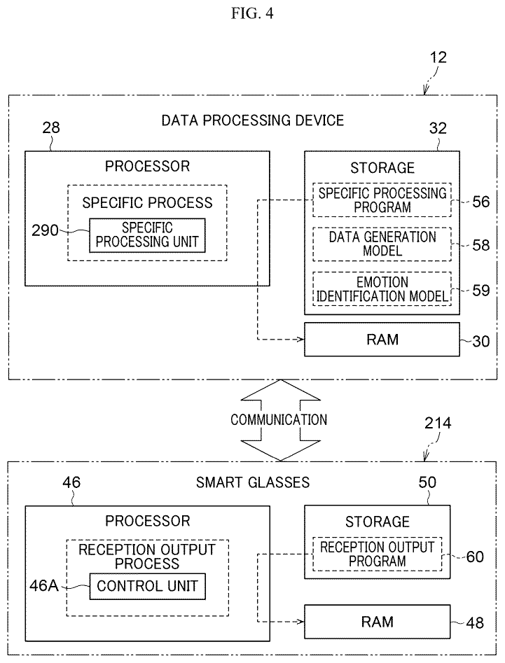

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

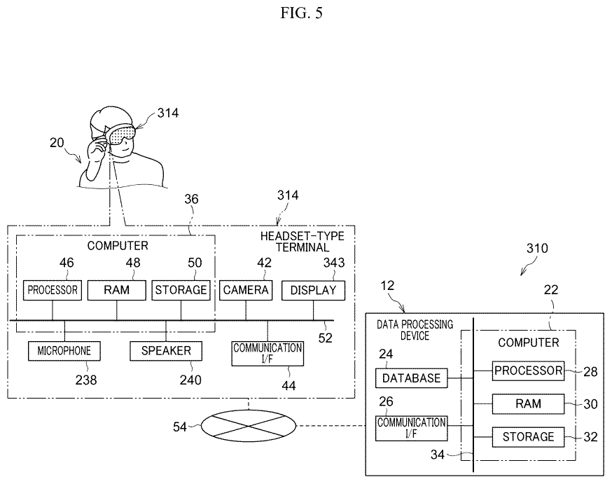

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

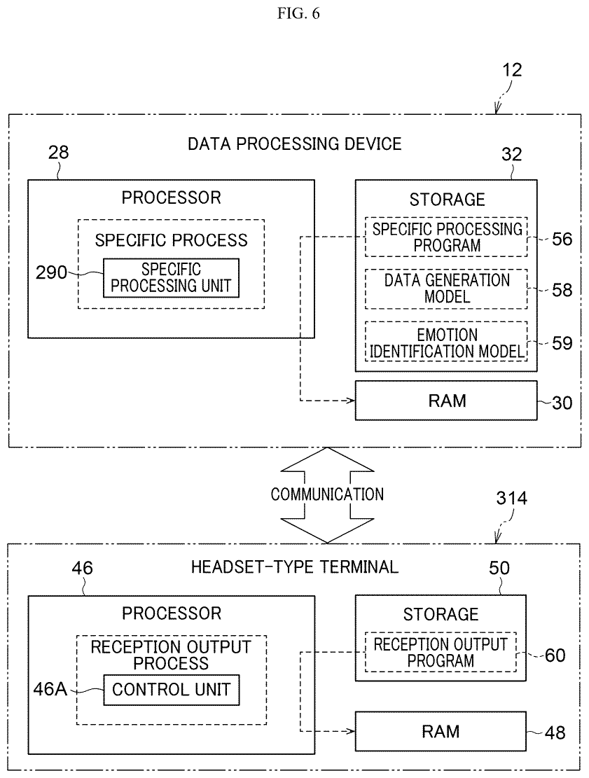

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

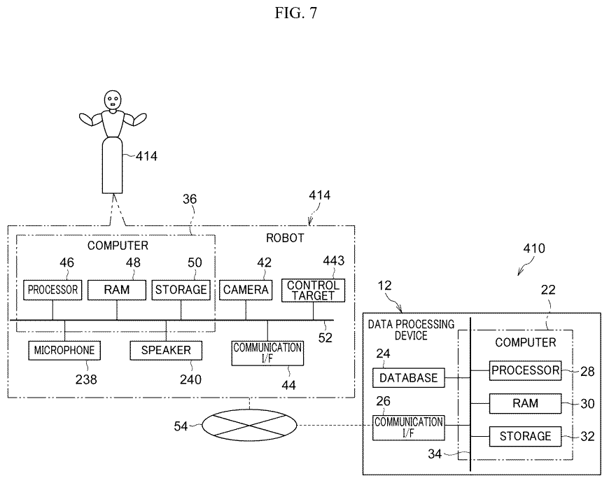

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

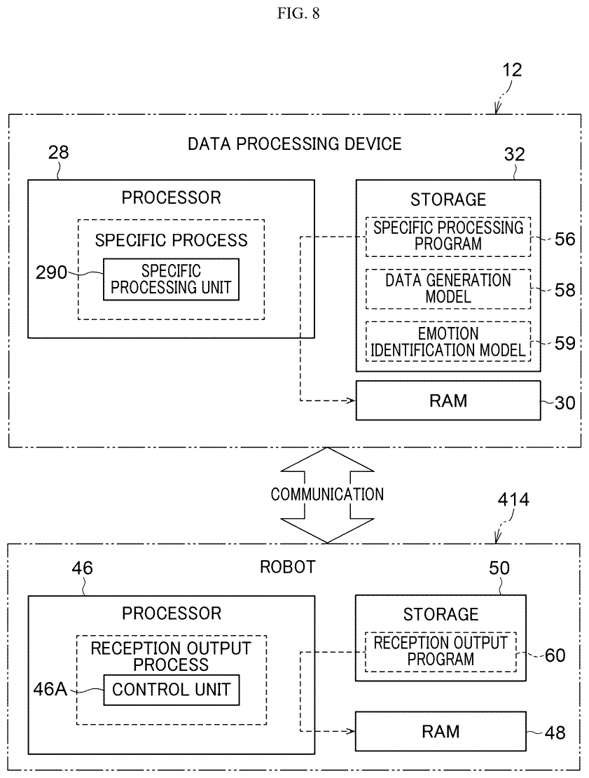

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

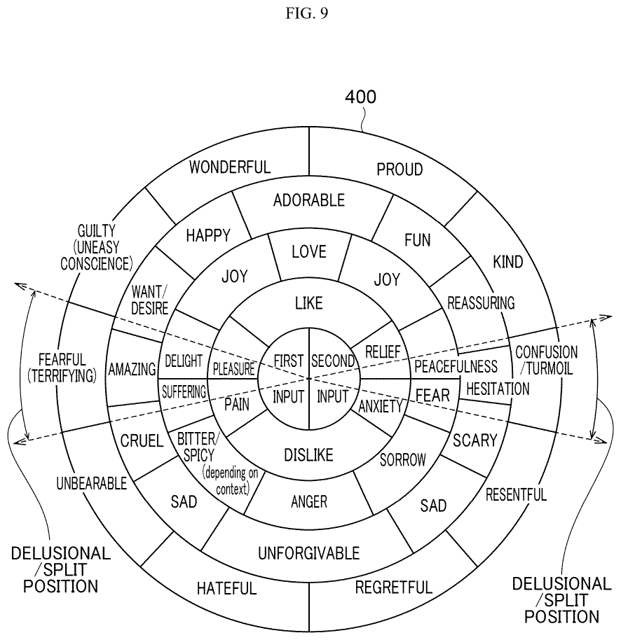

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

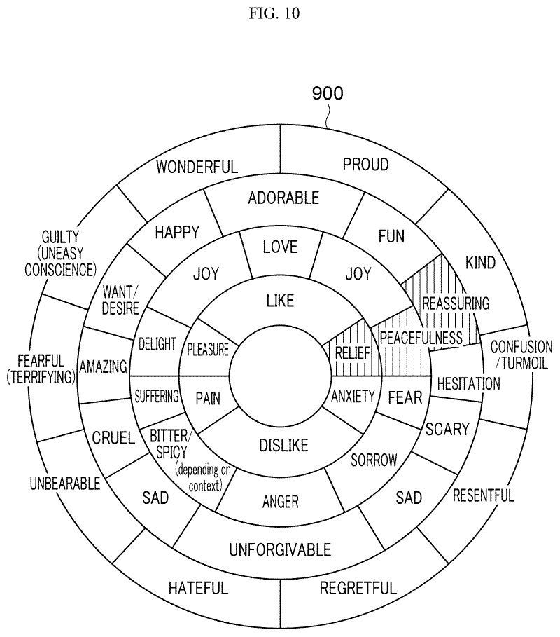

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
cause a terminal to present, on a user interface, an information input screen that receives product-related information as character data from a user, and to receive communication data including the product-related information from the terminal,
store the product-related information received as the communication data in a structured storage area, and acquire the product-related information from the structured storage area, generate a prompt sentence, as an instruction sentence to be input to a generative AI model, based on the product-related information acquired from the structured storage area, transmit inquiry data including the prompt sentence to the generative AI model, and acquire response data including recommendation information related to the product from the generative AI model,
generate display data for presenting the recommendation information included in the response data to the user in association with the product-related information, and transmit the display data to the terminal,
change at least one of the prompt sentence used for the generative AI model and the display data in accordance with an emotional state or a reaction state of the user with respect to the product-related information, and thereby adjust content or a presentation format of the recommendation information,
perform natural language processing for analyzing the product-related information, and based on an analysis result, perform preprocessing of the prompt sentence to be input to the generative AI model,
and change the prompt sentence even when the product-related information is identical, so as to enable acquisition of mutually different recommendation information or advertising information from the generative AI model for the identical product-related information.

### Supplementary 2

The system according to supplementary 1,
wherein the processor is configured to
generate the prompt sentence used for the generative AI model as content that instructs generation of creative advertising information in a comic format or a narrative format, acquire the advertising information in the comic format or the narrative format as the response data from the generative AI model, and include the advertising information in the display data.

### Supplementary 3

The system according to supplementary 1,
wherein the processor is configured to
switch and generate the prompt sentence used for the generative AI model in accordance with the product-related information, the emotional state or the reaction state of the user, and usage history information of the user, and, by using a plurality of different prompt sentences,
acquire from the generative AI model mutually different conversational advertising information or recommendation information for identical product-related information, and optimize the advertising information or the recommendation information in accordance with the emotional state or the reaction state of the user.

### Application Example 1

### Supplementary 1

A system comprising a processor,
wherein the processor is configured to
receive product information as input,
analyze the product information using natural language processing and perform preprocessing on the product information,
generate a prompt sentence by fitting the preprocessed product information into a predetermined template, the prompt sentence instructing a generative AI model to generate related product information or advertisement information,
transmit a request including the prompt sentence to an external generative AI model and obtain response data from the generative AI model, the response data including the related product information or the advertisement information,
analyze the response data to extract candidates of related products or advertisement contents and structure the extracted candidates as output data in a list format or a dialogue format,
adjust the output data according to a user emotional state or a user usage state, format the adjusted output data as display data, and transmit the display data to a terminal device, and
store a correspondence among the product information, the prompt sentence, and the response data, and control whether to make an inquiry to the generative AI model for similar input based on the stored correspondence.

### Supplementary 2

The system according to supplementary 1,
wherein the processor is configured to
generate the prompt sentence so as to distinguish among a request for proposing related product information, a request for generating advertisement content in a conversational format, and a request for generating advertisement content in a comic or other visual expression format, and to switch a format of the response data to be obtained from the generative AI model according to the request.

### Supplementary 3

The system according to supplementary 1,
wherein the processor is configured to
change instruction content or control parameters in the prompt sentence, even when the product information is the same, to cause the generative AI model to generate different related product information or different advertisement contents, and dynamically generate the prompt sentence for optimizing the output data according to the user emotional state or a user behavior history.

### Example 2

### Supplementary 1

A system comprising a processor,
wherein the processor is configured to
receive, from a terminal, a prompt sentence including product information, validate existence and length of the prompt sentence, and analyze the prompt sentence to extract the product information,
perform natural language preprocessing on the extracted product information, the natural language preprocessing including at least morphological analysis, tokenization, removal of unnecessary words, and normalization of word forms, and generate preprocessed data suitable for input to a generative AI model,
generate a model-level prompt sentence including the preprocessed data and an instruction text defining a creation policy of a conversation-type advertisement and roles of dialogue participants, and input the model-level prompt sentence to the generative AI model to cause the generative AI model to generate conversation-type advertisement text,
perform postprocessing on the generated conversation-type advertisement text, the postprocessing including at least assigning speaker labels, formatting line breaks, checking grammar and notation, and adjusting the conversation-type advertisement text to a predetermined number of dialogue turns or characters, and generate postprocessed advertisement text,
adjust a writing style, a length, and an appeal content of at least one of the model-level prompt sentence and the postprocessed advertisement text based on an emotion parameter corresponding to an emotional state of a user, and generate advertisement text adapted to the emotional state of the user,
transmit the generated advertisement text to the terminal and cause the generated advertisement text to be displayed to the user on the terminal, and
receive, from the terminal, a re-input prompt sentence or additional condition from the user, and perform control to repeatedly generate different conversation-type advertisement text for same product information by changing the model-level prompt sentence.

### Supplementary 2

The system according to supplementary 1,
wherein the processor is configured to
set the model-level prompt sentence to include an instruction for generating advertisement text in a visual expression format including a plurality of panels, characters, and utterances, and cause the generative AI model to generate comic-type creative advertisement text.

### Supplementary 3

The system according to supplementary 1,
wherein the processor is configured to
select or generate a plurality of different model-level prompt sentences in accordance with the emotion parameter indicating the emotional state of the user so as to change at least a tone, a dialogue structure, and an amount of information of the conversation-type advertisement text to be generated, and generate a plurality of types of advertisement text corresponding to the emotional state of the user for the same product information.

### Application Example 2

### Supplementary 1

A system comprising a processor,
wherein the processor is configured to
acquire, from a user terminal, information related to a product and a natural language instruction sentence input by a user, convert the information related to the product into structured attribute information by using a natural language processing technique, and
analyze facial information and voice information acquired from the user terminal by using an emotion recognition technique to specify an emotional state of the user,
generate, on the basis of the structured attribute information and the emotional state, a prompt sentence for instructing a generative AI model to generate conversation-type advertisement content, transmit the prompt sentence to the generative AI model, and obtain the conversation-type advertisement content from the generative AI model,
adjust, for the obtained conversation-type advertisement content, wording, expression, length, and medium format in accordance with the emotional state and a display capability of the user terminal, generate optimized advertisement content including at least one of a text format, a still-image format, and a moving-image format, output the optimized advertisement content to the user terminal, and convert the optimized advertisement content into a data format for sharing via an external information providing service and transmit the data format, and
record the prompt sentence, a response from the generative AI model, the emotional state, and an operation history regarding approval or correction by the user, and update generation rules for the prompt sentence and parameter settings for the generative AI model on the basis of the record to improve subsequent advertisement content generation processing.

### Supplementary 2

The system according to supplementary 1,
wherein the processor is configured to
generate, on the basis of the structured attribute information and the emotional state, a prompt sentence for instructing the generative AI model to generate story-type advertisement content including dialogue between characters and scene configuration, create layout information for adding visual elements for expressing the story-type advertisement content as an image sequence, and output comic-style advertisement content to the user terminal on the basis of the layout information.

### Supplementary 3

The system according to supplementary 1,
wherein the processor is configured to
generate, for identical structured attribute information, a plurality of different prompt sentences according to an emotional tone of advertisement content to be generated, a dialogue pattern, a medium format, and an output destination information providing service, provide the plurality of different prompt sentences sequentially or selectively to the generative AI model so as to generate a plurality of types of conversation-type advertisement content for identical information related to the product, and individually optimize each piece of the advertisement content on the basis of the emotional state of the user.

What is claimed is:

1. A system comprising:
circuitry configured to:
receive, via a communication interface coupled to a packet-switched network, character data representing input information from a terminal device, and store the character data in a structured storage area;
retrieve the character data from the structured storage area and apply natural language preprocessing including at least morphological analysis, tokenization, removal of unnecessary words, and normalization of word forms to generate preprocessed data;
generate a prompt sentence by fitting the preprocessed data into a predetermined template, the prompt sentence including the preprocessed data and an instruction text defining a generation policy and a structured output format;
transmit the prompt sentence to a generative neural network model and receive response data generated by the generative neural network model in response to the prompt sentence, and analyze the response data to extract candidate output content and structure the extracted candidates as output data;
apply postprocessing to the output data including at least speaker label assignment, line break formatting, grammar checking, and length adjustment to a predetermined number of turns or characters to generate postprocessed output text;
adjust a writing style, a length, and an appeal content of at least one of the prompt sentence and the postprocessed output text based on an emotion parameter corresponding to an estimated emotional state of a user; and
store a correspondence among the character data, the prompt sentence, and the response data in a storage device, and transmit display data including the postprocessed output text to the terminal device via the communication interface.

2. The system according to claim 1, wherein the circuitry is configured to change the prompt sentence while the character data remains identical by selecting a different template or varying the instruction text, and transmit the changed prompt sentence to the generative neural network model to obtain mutually different response data for the identical character data.

3. The system according to claim 2, wherein the circuitry is configured to check the stored correspondence in the storage device before transmitting the prompt sentence to the generative neural network model, and when a stored response exists for the same character data and prompt configuration, retrieve the stored response data without invoking the generative neural network model.

4. The system according to claim 3, wherein the circuitry is configured to receive feedback data from the terminal device in response to the displayed output text, update the emotion parameter based on the feedback data, and regenerate the prompt sentence with the updated emotion parameter to obtain adjusted response data from the generative neural network model.

5. The system according to claim 4, wherein the circuitry is configured to generate a second prompt sentence instructing the generative neural network model to generate output in a visual narrative format including a plurality of panels, scene descriptions, and dialogue elements, and transmit the second prompt sentence to the generative neural network model to obtain visual narrative output data.

6. The system according to claim 1, wherein the circuitry is configured to validate the character data upon receipt by checking at least existence and length constraints, and reject character data that fails the validation constraints prior to storing the character data in the structured storage area.

7. The system according to claim 6, wherein the circuitry is configured to perform morphological analysis on the character data using a trained language analysis model to identify part-of-speech tags, and extract noun phrases, attribute terms, and domain-specific feature terms as structured feature tokens for inclusion in the preprocessed data.

8. The system according to claim 7, wherein the circuitry is configured to apply word form normalization including stemming or lemmatization to the extracted feature tokens, and remove stop words and low-frequency tokens based on a frequency threshold to generate a compact structured representation of the character data.

9. The system according to claim 8, wherein the circuitry is configured to generate a plurality of prompt sentences from the preprocessed data by applying different template configurations, and transmit each prompt sentence to the generative neural network model to generate a plurality of output data sets, and select among the plurality of output data sets based on a selection criterion derived from the emotion parameter.

10. The system according to claim 1, wherein the circuitry is configured to estimate the emotional state of the user from at least one of audio data, image data, and text data received from the terminal device, and generate the emotion parameter as a numerical value representing the estimated emotional state.

11. The system according to claim 10, wherein the circuitry is configured to select a template variant from among a plurality of predefined templates based on the emotion parameter, and use the selected template variant to generate the prompt sentence.

12. The system according to claim 11, wherein the circuitry is configured to adjust the writing style of the postprocessed output text by modifying formality level and sentence length in accordance with the emotion parameter, and transmit a personalized version of the display data to the terminal device.

13. The system according to claim 1, wherein the circuitry is configured to analyze the response data to extract a plurality of candidates of output content, and structure the candidates as output data in a list format including ranked candidate entries each associated with a relevance score.

14. The system according to claim 13, wherein the circuitry is configured to format the ranked candidate entries as display data and transmit the display data to the terminal device, and receive a selection input from the terminal device identifying a selected candidate, and store the selection input in the storage device as feedback for subsequent prompt optimization.

15. The system according to claim 14, wherein the circuitry is configured to adjust the output data according to a user reaction state detected from interaction data received from the terminal device, and update the stored correspondence in the storage device with the reaction state to enable subsequent optimization of prompt generation.

16. The system according to claim 1, wherein the circuitry is configured to generate a model-level prompt sentence including the preprocessed data and an instruction text defining roles of dialogue participants, and input the model-level prompt sentence to the generative neural network model to generate dialogue-structured text including attributed speaker turns.

17. The system according to claim 16, wherein the circuitry is configured to apply postprocessing to the dialogue-structured text by assigning speaker labels, adjusting the number of dialogue turns to a target range, and removing repeated or inconsistent utterances, and store the postprocessed dialogue text in the structured storage area indexed by a session identifier.

18. A system comprising:
circuitry configured to:
receive, via a communication interface coupled to a packet-switched network, character data from a terminal device, and apply natural language preprocessing including morphological analysis, tokenization, stop word removal, and word form normalization to generate preprocessed data;
generate a prompt sentence by fitting the preprocessed data into a predetermined template including the preprocessed data and an instruction text, and transmit the prompt sentence to a generative neural network model;
receive response data from the generative neural network model and apply postprocessing including speaker label assignment, line break formatting, grammar checking, and length adjustment to generate postprocessed output text;
adjust a writing style and appeal content of at least one of the prompt sentence and the postprocessed output text based on an emotion parameter corresponding to an estimated emotional state of a user;
change the prompt sentence while the character data remains identical by selecting a different template configuration to obtain mutually different response data from the generative neural network model; and
store a correspondence among the character data, the prompt sentence, and the response data in a storage device, and transmit display data including the postprocessed output text to the terminal device via the communication interface.

19. The system according to claim 18, wherein the circuitry is configured to check the stored correspondence before transmitting the prompt sentence to the generative neural network model, and retrieve stored response data without invoking the generative neural network model when a stored response exists for the same character data and prompt configuration.

20. A method comprising:
receiving, by circuitry via a communication interface coupled to a packet-switched network, character data representing input information from a terminal device, and storing the character data in a structured storage area;
retrieving the character data from the structured storage area and applying natural language preprocessing including at least morphological analysis, tokenization, removal of unnecessary words, and normalization of word forms to generate preprocessed data;
generating a prompt sentence by fitting the preprocessed data into a predetermined template including the preprocessed data and an instruction text defining a generation policy and a structured output format;
transmitting the prompt sentence to a generative neural network model and receiving response data generated by the generative neural network model, and analyzing the response data to extract candidate output content and structure the candidates as output data;
applying postprocessing to the output data including speaker label assignment, line break formatting, grammar checking, and length adjustment to generate postprocessed output text;
adjusting a writing style, a length, and an appeal content of at least one of the prompt sentence and the postprocessed output text based on an emotion parameter corresponding to an estimated emotional state of a user; and
storing a correspondence among the character data, the prompt sentence, and the response data in a storage device, and transmitting display data including the postprocessed output text to the terminal device via the communication interface.
